(19) United States
(12) Patent Application Publication
(10) Pub. No.: US 2013/0189375 A1
(43) Pub. Date: Jul. 25, 2013

(54) BIOCIDAL IRON OXIDE COATING, METHODS OF MAKING, AND METHODS OF USE

(71) Applicant: UNIVERSITY OF GEORGIA RESEARCH FOUND, Athens, GA (US)

(72) Inventors: Yiping Zhao, Statham, GA (US); Yen-Con Hung, Peachtree City, GA (US); Pradip Basnet, Athens, GA (US); Ravirajsinh Jadeja, Griffin, GA (US)

(73) Assignee: UNIVERSITY OF GEORGIA RESEARCH FOUNDATION, INC., Athens, GA (US)

(21) Appl. No.: 13/747,894

(22) Filed: Jan. 23, 2013

Related U.S. Application Data
(60) Provisional application No. 61/589,631, filed on Jan. 23, 2012.

(51) Int. Cl. A01N 59/16; B01J 23/745

(52) U.S. Cl. CPC A01N 59/16; B01J 23/745
USPC 424/647; 423/633; 502/338

(57) ABSTRACT

Embodiments of the present disclosure include visible light antimicrobial materials comprising α-Fe₂O₃ nanostructures fabricated by electron beam evaporation, methods of making the antimicrobial materials, and methods of using the antimicrobial materials.

### CROSS-REFERENCE TO RELATED APPLICATION

This application claims priority to co-pending U.S. provisional application entitled “Biocidal Iron Oxide Coating,” having Ser. No. 61/589,631 filed on Jan. 23, 2012, which is entirely incorporated herein by reference.

### STATEMENT REGARDING FEDERALLY SPONSORED RESEARCH OR DEVELOPMENT

This invention was made with Government support under USDA Grant #2011-68003-30012, awarded by the U.S. Department of Agriculture. The Government has certain rights in this invention.

### BACKGROUND

Escherichia coli O157:H7 is a well known food borne pathogen, responsible for 73,000 illnesses annually and costs the United States approximately $405 million in medical expenses. E. coli O157:H7 infection often leads to bloody diarrhea and hemolytic uremic syndrome (HUS). This pathogen is naturally present in the intestinal tract of cattle; hence the contamination of beef products with bovine feces is the primary source of E. coli O157:H7. Besides direct contact with bovine feces, beef products can be contaminated with E. coli O157:H7 by coming in contact with contaminated beef processing equipment. Microbial contamination is a serious issue within the food industry. Therefore, there is an urgent need to develop effective antimicrobial agents to help eliminate this pathogen, among others, and control its spread in ground beef and beef-processing environments.

### SUMMARY

Embodiments of the present disclosure, in one aspect, relate to iron oxide (e.g., Fe₂O₃) thin films, nanoparticles, and nanorod arrays for antimicrobial and photocatalytic applications.

Briefly described, embodiments of the present disclosure include an antimicrobial material comprising iron oxide, where the iron oxide is selected from iron (III) oxide (Fe₂O₃), iron (II) oxide (FeO), iron (II, III) oxide (Fe₃O₄), and a combination thereof.

Embodiments of the present disclosure include a method of making an antimicrobial iron oxide material comprising depositing iron oxide by a physical method on a substrate to form a sample, where the physical method is selected from electron beam physical vapor deposition, oblique angle deposition (OAD), glancing angle deposition (GLAD), chemical precipitation, and a combination thereof, and where the iron oxide is selected from iron (III) oxide (Fe₂O₃), iron (II) oxide (FeO), iron (II, III) oxide (Fe₃O₄), and a combination thereof, and annealing the sample, where the sample is annealed at about 250 to 450° C.

Embodiments of the present disclosure include a method of killing bacteria comprising exposing at least one bacterium to an antimicrobial material comprising α-Fe₂O₃ under visible light.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

The patent or application file contains at least one drawing executed in color. Copies of this patent or patent application publication with color drawing(s) will be provided by the Office upon request and payment of the necessary fee.

FIGS. 1A-1D illustrate XRD spectra of as-deposited and annealed Fe₂O₃ samples, prepared by e-beam technique (annealing temperatures are labeled inside the figures): (FIG. 1A) Thin film (deposited on Si substrate), (FIG. 1B) OAD nanorods (deposited on Si substrate) and (FIG. 1C) GLAD nanorods (deposited on Glass substrate). FIG. 1D illustrates comparison of peaks and relative intensities of about 450° C. annealed GLAD sample for hematite, αFe₂O₃.

FIGS. 2A-2D are SEM images of GLAD and OAD as-deposited nanorod arrays. (FIG. 2A) Top-view, (FIG. 2B) Cross-sectional view, of GLAD nanorods and (FIG. 2C) Top-view, (FIG. 2D) Cross-sectional view, of OAD nanorods.

FIGS. 3A-3C illustrate as-deposited Fe₂O₃ samples, deposited on glass-substrates: (FIG. 3A) OAD nanorods array, (FIG. 3B) GLAD nanorods array and (FIG. 3C) thin film (TF).

FIGS. 4A-4B illustrate absorption spectra of TF, OAD and GLAD as-deposited FeOx samples, deposited on glass substrates, by e-beam technique.

FIGS. 5A-5B are graphs that illustrate Tauc plots. (FIG. 5A) Calculation of direct transition and (FIG. 5B) Calculation of indirect transition for Fe₂O₃ as-deposited samples, deposited on glass substrate; arrows indicate the estimated optical band gaps.

FIGS. 6A-6B are graphs that illustrate absorbance spectra of MB aq solution of different concentrations: (FIG. 6A) recorded by USB-2000 (Ocean Opics) and (FIG. 6B) JASCO-|V|-570 Spectrophotometer.

FIGS. 7A-7D are graphs that illustrate visible-light-induced photocatalytic MB degradation: (FIG. 7A) absorbance spectra as a function of time, (FIGS. 7B-7D) normalized absorbance of MB aq solution comparison of different structures as well as as-deposited and annealed samples.

FIG. 8 is a graph that illustrates comparison of decay rates of as-deposited and annealed samples (annealed at 4 different temperatures).

FIG. 9 is a graph that illustrates efficacy of FeOX thin films against E. coli O157:H7 cocktail.

FIG. 10 is a graph that illustrates efficacy of FeOX nanorods (annealed at about 350° C.) against E. coli O157:H7 cocktail.

FIG. 11 is a graph that illustrates efficacy of FeOX nanorods (as deposited) against E. coli O157:H7.

FIG. 12 is a graph that illustrates XRD patterns of α-Fe₂O₃ nanoparticles (NPs): commercial and prepared by Co-precipitation method. The commercial sample (Fe₂O₃, alpha, 98+%, 20-40 nm) was purchased from US research Nanomaterials, Inc.

FIGS. 13A-13H are TEM micrographs of α-Fe₂O₃ NPs, prepared by Co-precipitation method.

FIGS. 14A-14B are graphs that illustrate DLS results for Fe₂O₃ NPs size distribution. FIG. 14A: without shaking the stock solution of NPs suspension, before dilution, and FIG. 14B: after shaking well the stock solution.

FIG. 15 is a graph that illustrates no degradation of MB solution in dark for four hours (with Fe₂O₃ NPs).

FIGS. 16A-16B are graphs that illustrate no degradation of MB solution (FIG. 16A) and curve fitting for decay rate estimation for MB solution by loading 0.2 mg/ml of Fe₂O₃ NPs.

FIGS. 17A-17D are SEM micrographs of (FIG. 17A) top-view and (FIG. 17B) cross-sectional view of the as-deposited Fe₂O₃ thin film, and (FIG. 17C) top-view and (FIG. 17D) cross-sectional view of the as-deposited Fe₂O₃ OAD nanorod film. Inset in (A) shows the histogram of the measured angle between the prismatic facets at the nanocolumn ends, which are defined in the inset in (B). The scale bars are all equal to 1 μm.

FIGS. 18A-18B are XRD spectra with peak attributions of the Fe₂O₃ (FIG. 18A) thin films and (FIG. 18B) OAD nanorods deposited on silicon substrates. Note that the spectra have been shifted vertically for clarity.

FIG. 19 illustrates Pole figures of the Fe₂O₃ thin film and OAD nanorods annealed at T=about 350° C. for the {110}, {012}, and {104} crystal plane reflections of α-Fe₂O₃. Note that the nanorod sample was oriented such that the tilting direction was pointed toward the X-ray source at θ=0°, ψ=0°.

FIGS. 20A-20B are Raman spectra of the as-deposited and about 450° C. annealed Fe₂O₃ (FIG. 20A) thin films and (FIG. 20B) OAD nanorods. Note that the spectra have been shifted vertically for clarity.

FIGS. 21A-21B illustrate transmission spectra of the Fe₂O₃ (FIG. 21A) thin films and (FIG. 21B) OAD nanorods. Insets show a representative photographic image of a (A) thin film and (B) nanorod sample, deposited on glass substrates placed over a University of Georgia logo.

FIGS. 22A-22B are graphs that illustrate normalized MB absorbance intensities of the λ=663.71 nm peak versus time for the Fe₂O₃ (FIG. 22A) thin films and (FIG. 22B) OAD nanorods. The curves correspond to the first-order exponential decay fittings of the data points, from which the decay rate, κ, was determined.

FIGS. 23A-23B are graphs that illustrate log reduction of E. coli O157:H7 as a function of irradiation time for the as-deposited and T=about 350° C. Fe₂O₃ (A) thin films and (B) OAD nanorods. The solid curves are the chemotaxis model fits for the log reduction.

### DETAILED DESCRIPTION

Before the present disclosure is described in greater detail, it is to be understood that this disclosure is not limited to particular embodiments described, as such may, of course, vary. It is also to be understood that the terminology used herein is for the purpose of describing particular embodiments only, and is not intended to be limiting, since the scope of the present disclosure will be limited only by the appended claims.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. Where the stated range includes one or both of the limits, ranges excluding either or both of those included limits are also included in the disclosure.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present disclosure, the preferred methods and materials are now described.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present disclosure is not entitled to antedate such publication by virtue of prior disclosure. Further, the dates of publication provided could be different from the actual publication dates that may need to be independently confirmed.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure. Any recited method can be carried out in the order of events recited or in any other order that is logically possible.

The following examples are put forth so as to provide those of ordinary skill in the art with a complete disclosure and description of how to perform the methods and use the compositions and compounds disclosed and claimed herein. Efforts have been made to ensure accuracy with respect to numbers (e.g., amounts, temperature, etc.), but some errors and deviations should be accounted for. Unless indicated otherwise, parts are parts by weight, temperature is in ° C., and pressure is at or near atmospheric. Standard temperature and pressure are defined as 20° C. and 1 atmosphere.

It must be noted that, as used in the specification and the appended claims, the singular forms “a,” “an,” and “the” include plural referents unless the context clearly dictates otherwise. Thus, for example, reference to “a support” includes a plurality of supports. In this specification and in the claims that follow, reference will be made to a number of terms that shall be defined to have the following meanings unless a contrary intention is apparent.

### Discussion:

In accordance with the purpose(s) of the present disclosure, as embodied and broadly described herein, embodiments of the present disclosure, in one aspect, relate to biocidal (e.g., antimicrobial) iron oxide (e.g., Fe₂O₃) coatings, methods of making biocidal iron oxide (e.g., Fe₂O₃) coatings, and methods of using biocidal iron oxide (e.g., Fe₂O₃) coatings. Embodiments of the present disclosure include coatings for antimicrobial/biocidal activity of human pathogens (e.g., both the gram positive and gram negative bacteria) (e.g., S. aureus and E. coli respectively.).

Embodiments of the present disclosure include Fe₂O₃ nanostructures prepared by physical means for highly effective antibacterial applications. Embodiments of the present disclosure include Fe₂O₃ thin film, nanoparticles, and nanorod arrays, prepared by physical means such as physical vapor deposition or mechanical milling, which are used to kill bacteria and prevent bacterial growth under normal white light illumination (as compared, for example, to TiO₂ which requires UV light).

Embodiments of the present disclosure include thin film and nanorod arrays of iron oxide (e.g., Fe₂O₃) that can be used to kill bacteria (e.g., E. coli) and prevent bacterial growth under normal white light illumination. In an embodiment, bacteria (e.g., E. coli O157:H7) can be killed within about 2 to 3 hours.

Embodiments of the present disclosure include biocidal agents (e.g., Fe₂O₃) that are FDA approved materials that can be used for food (e.g., food packaging, food coating) and human applications (e.g., wound treatment), and/or for preventing biofilm growth.

Embodiments of the present disclosure can also be used for tile coating, curtain coating, tool coating, and the like, to prevent biofilm formation and/or kill bacteria. In an embodiment, Fe₂O₃ nanoparticle paints are used for tile coating, curtain coating, tool coating, and the like to prevent biofilm formation or to kill bacteria.

Embodiments of the present disclosure include a biocidal iron oxide coating comprising iron oxide and a substrate. In an embodiment, the iron oxide is selected from: iron (III) oxide (Fe₂O₃), iron (II) oxide (FeO), iron (II, III) oxide (Fe₃O₄), and a combination thereof.

Embodiments of the present disclosure include a biocidal iron oxide coating where the iron oxide comprises a thin film. In an embodiment, the thickness of the iron oxide film is about 1 μm.

Embodiments of the present disclosure include a biocidal iron oxide coating where the iron oxide comprises an array of nanostructures. In an embodiment, the iron oxide comprises an array of nanorods. In another embodiment, the thickness of the nanorod array is about 1 to 2 μm.

Embodiments of the present disclosure include substrates selected from: glass, silicon, and a combination thereof.

Embodiments of the present disclosure include a method of making a biocidal iron oxide coating comprising depositing iron oxide on a substrate to form a sample and annealing the sample.

Embodiments of the present disclosure include a method of making a biocidal iron oxide coating where the deposition comprises oblique angle deposition (OAD) of nanostructures. In an embodiment, the nanostructures comprise nanorods. In another embodiment, the angle of deposition is at least about 70° (e.g., about 86°).

Embodiments of the present disclosure include a method of making a biocidal iron oxide coating where the deposition is performed under vacuum.

Embodiments of the present disclosure include a method of making a biocidal iron oxide coating where the sample is annealed at about 250 to 450° C.

Embodiments of the present disclosure include a method of making a biocidal iron oxide coating where the deposition comprises glancing angle deposition (GLAD) of nanostructures. In an embodiment, the nanostructures comprise nanorods. In another embodiment, the angle of deposition is about 86°.

Embodiments of the present disclosure include a method of making a biocidal iron oxide coating where the deposition comprises thin film deposition.

Embodiments of the present disclosure include iron oxide (e.g., Fe₂O₃) nanostructures or iron oxide (e.g., Fe₂O₃) film on polymers for intact and non-intact beef products/ground beef food packaging applications.

Embodiments of the present disclosure include providing a substrate and depositing the nanostructures (e.g., nanorods) on the substrate by a modified oblique angle deposition (OAD) technique/system or glancing angle deposition (GLAD), or other physical method such as ball milling. In an embodiment of a modified OAD technique, the OAD system can include a two-axis substrate motion apparatus in a physical vapor deposition (PVD) system (e.g., thermal evaporation, e-beam evaporation, sputtering growth, pulsed laser deposition, and the like) that operates at temperatures lower than the melting point of the material used to form the nanostructures. In an embodiment, the substrate motion system provides two rotation movements: one is the polar rotation, which changes angle between the substrate surface normal and the vapor source direction, and one is the azimuthal rotation, where the sample rotates about its center axis of rotation (e.g., normal principle axis).

At least one advantage of using the OAD system is that the nanostructures (e.g., nanorods) can be formed at temperatures compatible with substrates such as, but not limited to, optical fibers, waveguides, and the like. This is in contrast to other techniques that operate under conditions (e.g., high temperatures) that are not compatible with many substrates of interest. Another advantage of using the OAD system is that catalysts are not needed to form the nanostructures, in contrast to currently used technologies. Since a vacuum system is used, the purity of the nanostructures is very high, and the vacuum system is compatible with conventional microfabrication processes.

Embodiments of the present disclosure include an antimicrobial material (e.g., a biocidal coating) comprising iron oxide, where the iron oxide is selected from iron (III) oxide (Fe₂O₃), iron (II) oxide (FeO), iron (II, III) oxide (Fe₃O₄), and a combination thereof. In an embodiment, the iron oxide comprises α-Fe₂O₃ (i.e., hematite).

Embodiments of the present disclosure include an iron oxide antimicrobial material where the iron oxide comprises a thin film comprised of an array of prismatic nanocolumns fabricated by electron beam evaporation. The prismatic nanocolumns comprise columnar structures (e.g., which are very thin and closely packed) with prismatic ends. In an embodiment, the Fe₂O₃ thin films have fine, elongated granular surface features, which are the prismatic ends of vertical columnar like structures. In another embodiment, the thickness of the thin film is about 900 nm to 1 μm.

Embodiments of the present disclosure include an antimicrobial material that is photocatalytically and antimicrobially active under visible light illumination.

Embodiments of the present disclosure include a method of killing bacteria comprising exposing at least one bacterium to an antimicrobial material comprising α-Fe₂O₃ under visible light.

Embodiments of the present disclosure include an antimicrobial material where the iron oxide comprises an array of aligned, tilted nanorods fabricated by oblique angle deposition (OAD). In an embodiment, the nanorods are inclined at an angle β with respect to a substrate normal of about 40° to 50°. In another embodiment, the length of the individual nanorods is about 1450 to 1550 nm, and the density of the nanorods is about 5 to 15 rods/μm². In yet another embodiment, the porosity of the array of nanorods is at least about 60%.

Embodiments of the present disclosure include an antimicrobial material where the nanorod array comprises a film, where a thickness of the nanorod array film is about 1 to 2 μm.

Embodiments of the present disclosure include an antimicrobial material that kills bacteria in about 2 to 3 hours under visible light illumination. In another embodiment, the material kills bacteria on contact when exposed to visible light. In an embodiment, the bacteria comprise E. coli O157:H7.

Embodiments of the present disclosure include an antimicrobial material where the iron oxide comprises nanoparticles, where the nanoparticles comprise a shape selected from spherical, cubical, rod, and a combination thereof. In an embodiment, the iron oxide nanoparticles are fabricated by chemical precipitation.

Embodiments of the present disclosure include methods of making an antimicrobial material where the material is deposited by a method selected from electron beam physical vapor deposition, oblique angle deposition (OAD), chemical precipitation, and a combination thereof. In an embodiment, the OAD method comprises an angle of deposition that is at least about 70°. In another embodiment, the electron beam physical vapor deposition comprises depositing a thin film of iron oxide with a vapor incident angle of 0°.

### EXAMPLES

### Example 1

### Sample Preparation

Source material used: Fe₂O₃ (iron oxide, 99.85+%, metal base, Alfa Aesar); no further purification needed. System used: A unique custom designed vacuum deposition system equipped with an electron-beam evaporation source. Background pressure is about 1*10⁻⁶ Torr or better, and deposition is at room temperature. Substrate used: Glass and silicon wafer of size 2*2 cm² (cleaning procedure including time length is tabulated below, in Table 1). Growth/deposition rate set about (0.18-0.2) nm/Sec. Thickness: for thin film (TF)=about 1 μm and OAD, GLAD nanorods=about 2 μm (QCM reading). Deposition angle (w.r.t. substrate normal): 0° for TF, about 86° for OAD and GLAD; the substrate is kept fixed for OAD, while for GLAD the substrate rotated azimuthally with a constant rotation speed=about 0.25 rot/sec. Post-deposition treatments: anneal the samples at 3 different temperatures namely at about 250, 350 and 450° C. (details tabulated below, in Table 2)

TABLE 1
Substrates' Details.

| | Dimensions/ | | |
|---|---|---|---|
| Substrate | number | Cleaning agent(s) | Used for: |
| Silicon | 2 * 2 cm²/8 | DI H₂O:H₂O₂:NH₄OH | XRD (each sample: |
| | (1- as deposited, 3 | (5:1:1) | cutting into a size ~1 * 1 |
| | for each diff | => boiled about 15-20 mins | cm² will use be |
| | annealing temp) | till bubbles appear | used for XRD |
| | [Extra samples to | and let it cool down for | measurement) and |
| | repeat the expt.] | about 30 mins before | the rest half for SEM |
| | | wash with DI water. | morphology. |
| | | Finally dry with N₂ gas | |
| | | blow. | |
| Glass | (0.9 * 2.7 cm²)/12 | H₂SO₄:H₂O₂ (4:1) | 5- Rectangular |
| | (2 * 2 cm²)/12 | (Repeat the same | samples will be used |
| | (1- as deposited, 3 | protocol as above to | for optical |
| | for each diff | prepare clean/dry | measurement first |
| | annealing temp) | substrates) | (i.e. for UV/Vis) then |
| | [extra samples to | | for Photocatalytic |
| | repeat the | | activity |
| | experiment - 2 | | measurements (each |
| | more times] | | samples). The sq 5 |
| | | | for antimicrobial test. |

TABLE 2
Post-deposition Treatment: Annealing Details.

| Substrate | Temperature | Time | Heating rate/Annealing environment |
|---|---|---|---|
| Glass/Si | 250° C. | 4 hrs | 5° C./min; in an open environment |
| | | | (Air). |
| Glass/Si | 350° C. | 4 hrs | 5° C./min; Air. |
| Glass/Si | 450° C. | 4 hrs | 5° C./min; Air. |

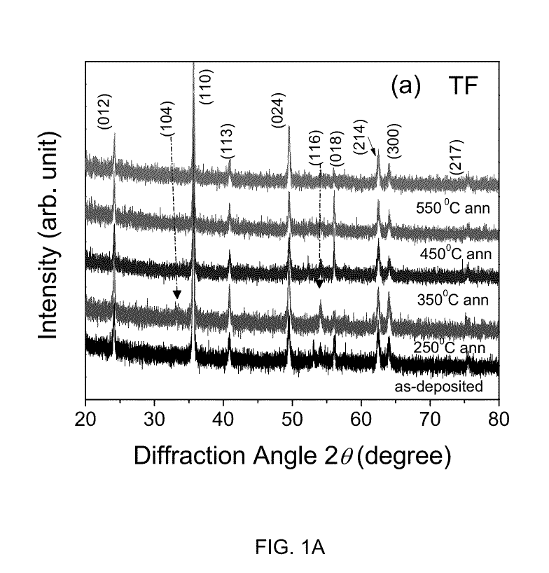

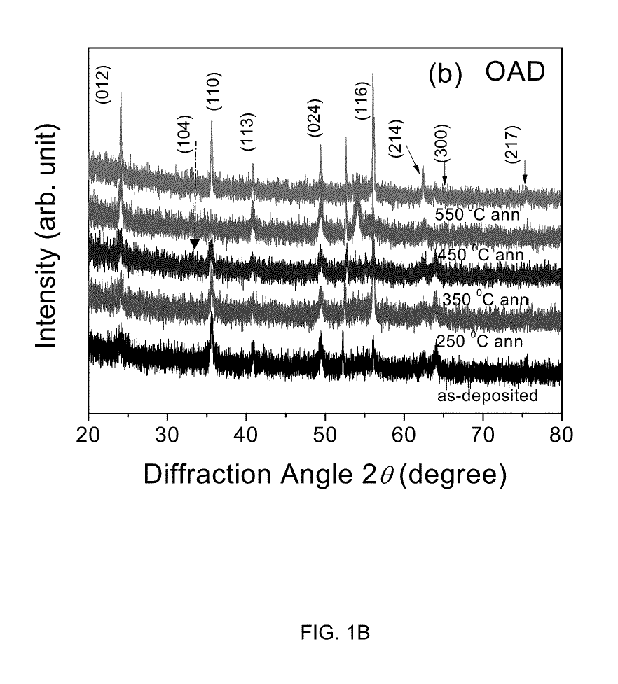

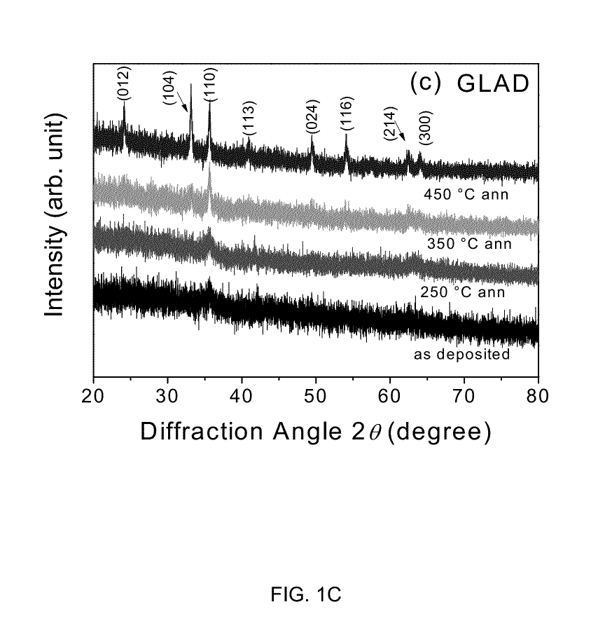

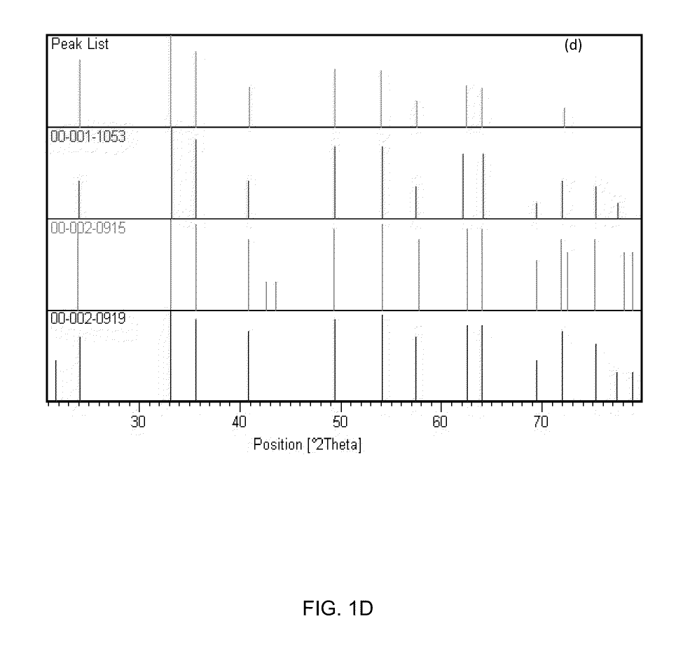

Note:
Si deposited samples can also be annealed at about 550° C. in the same conditions as mentioned above in order to test for the optimum conditions of crystallite size (see FIGS. 1A-1B).

### Structural Properties:

The XRD patterns were analyzed, observed for all the samples, by comparing with the JCPDS data to describe the phase and crystal sizes of the deposited polycrystalline materials (as shown in FIGS. 1A-1C). Also compared was whether there is a shift/change of phase with annealing.

The X-RD peaks of all the annealed samples are almost similar to those of as-deposited sample for that structure showing better crystallinity. About 450° C. annealed samples showed more intense peaks. After annealing at about 450° C., the GLAD deposited nanorods sample, emerges with the orientation changing to lie predominantly along the (104) plane (i.e., 450° C. annealed GLAD deposited sample preferentially oriented in the (104) direction on glass substrate). However, the most intense peak for TF and OAD samples did not correspond to (104) plane; all the peaks appearing in the XRD patterns, 24.17°, 33.22°, 35.74°, 40.92°, 49.47°, 54.15°, 57.76°, 62.54°, 64.13°, 71.91° are all corresponding to the peaks of α-Fe₂O₃ (see FIG. 1D, Rhombohedral phase).

Also calculate the average size of α-Fe₂O₃ crystallites by using Scherrer's equation (d=Kλ/β cos θ). Where, the shape factor, K=0.90, and the wavelength, λ=1.540598 Å, will be used for the maximum intensity at FWHM (β). And, θ is the angle of diffraction.

TABLE 3
crystallite size calculated from XRD patterns; using peaks at 30 ≦ 2θ ≦ 50
(i.e. at two intense peaks namely: at (012) and (110) planes, see FIGS. 1A-C).

| | Sample | | | | | | | | | | | |
|---|---|---|---|---|---|---|---|---|---|---|---|---|
| | TF | | | | OAD | | | | GLAD | | | |
| | As- | 250° | 350° | 450° | As- | 250° | 350° | 450° | As- | 250° | 350° | 450° |
| | depo | C. | C. | C. | depo | C. | C. | C. | depo | C. | C. | C. |
| Dₕₖₗ @ | 59 | 68.8 | 68.8 | 82.6 | 17.2 | 41.3 | 29.5 | 41.3 | | | 43 | 45.9 |
| (012); | | | | | | | | | | | | |
| (in nm) | | | | | | | | | | | | |
| Dₕₖₗ @ | 42.4 | 47.1 | 53 | 42.4 | 30.3 | 35.3 | 17.7 | 26.5 | 14.5 | 35.3 | 35.3 | 35.3 |
| (110); | | | | | | | | | | | | |
| (in nm) | | | | | | | | | | | | |

### SEM Image Analysis:

The following were calculated/estimated in order to interpret the antimicrobial activity observed for the Fe₂O₃ samples of different structure(s), as mentioned above:

a) Avg. vertical thickness of the deposited FeOx samples (t)
b) nanorod lengths (NR lengths, h)
c) Average column separation length (d)
d) NR density (θₛ)
e) Effective surface area (photocatalytic decay rates strongly, linearly depends on it)
f) Tilting angle (β).

And hence with all the above listed information, the observed results are linked for antimicrobial activity of the different samples—i.e., different nanostructures and also different crystalline sizes—based on their morphologies.

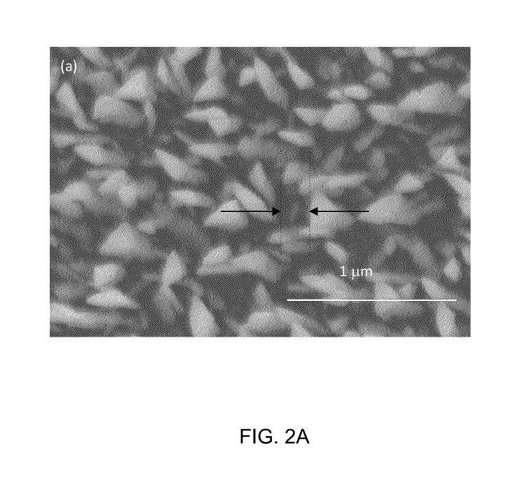

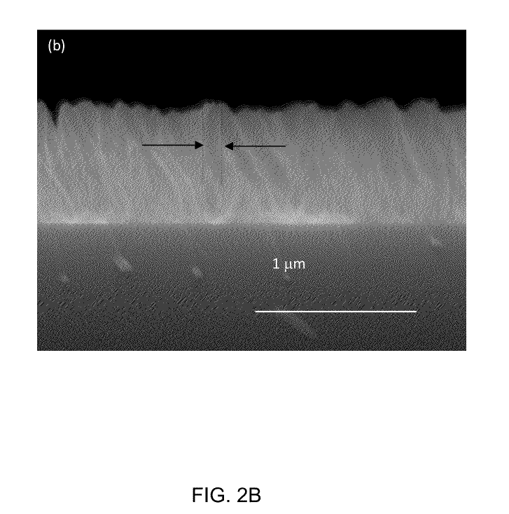

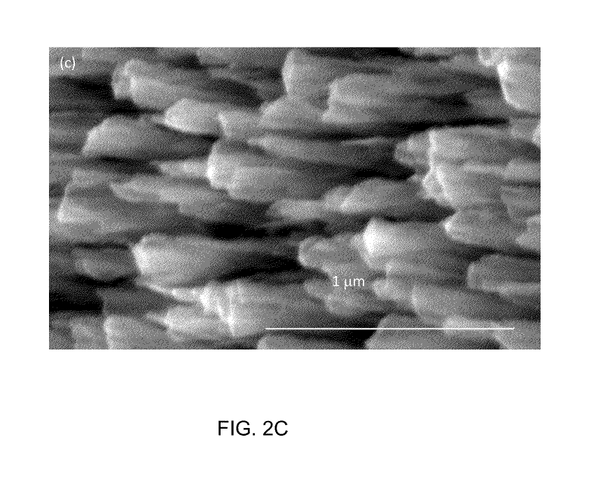

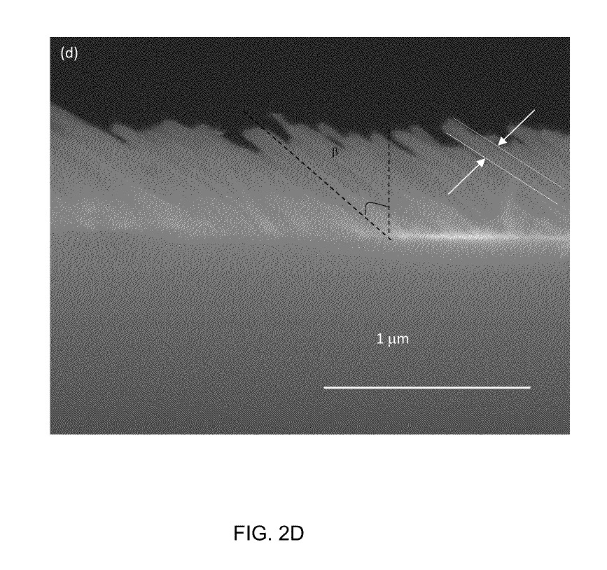

The average for each of the above parameters is estimated, from 3 samples about 50 measurements—each at 3 different locations; for, example SEM images are shown here, both the cross-section and top-view of a sample with magnification *80K (FIGS. 2A-2D).

TABLE 4
Summary of parameters measured from SEM image(s).

| | | | | Avg NR | | Effective |
|---|---|---|---|---|---|---|
| | Tilting angle (β) | NR | Diameter | separation | Avg NR | Surface area |
| | in deg/vertical | length | (near top) | distance | density: | comparison |
| Sample | thickness (nm) | (nm) | (nm) | (d); in nm | (μm⁻²) | w.r.t. TF (A) |
| GLAD | 716 ± 30 nm | 721 ± 33 | 115 ± 22 | 128 ± 31 nm | 15 ± 3 | ^{~}3*A |
| OAD | 47 ± 4 deg/ | 918 ± 57 | 67 ± 9 | | 9 ± 2 | ^{~}1.8*A |
| | 622 ± 49 nm | | | | | |

Note:
these data were obtained as average from 3 samples (about 50 measurements- each at 3 different locations).

### Optical Properties:

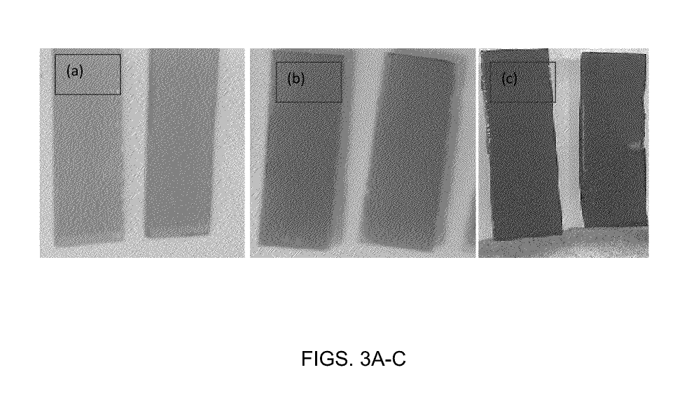

All the as-deposited samples are semi-transparent, seen in visible reflected light, as shown in FIGS. 3A-3C (transmittance increases slightly with annealing, not shown here).

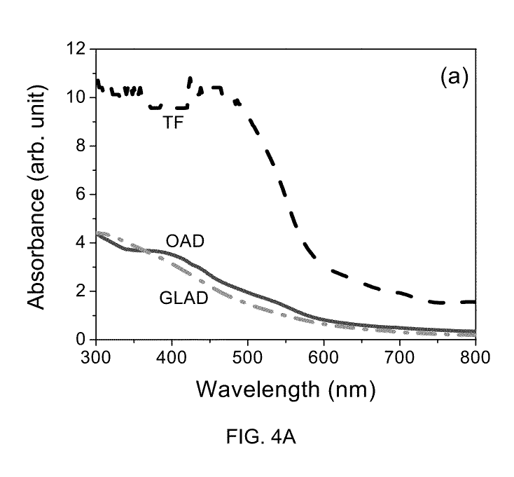

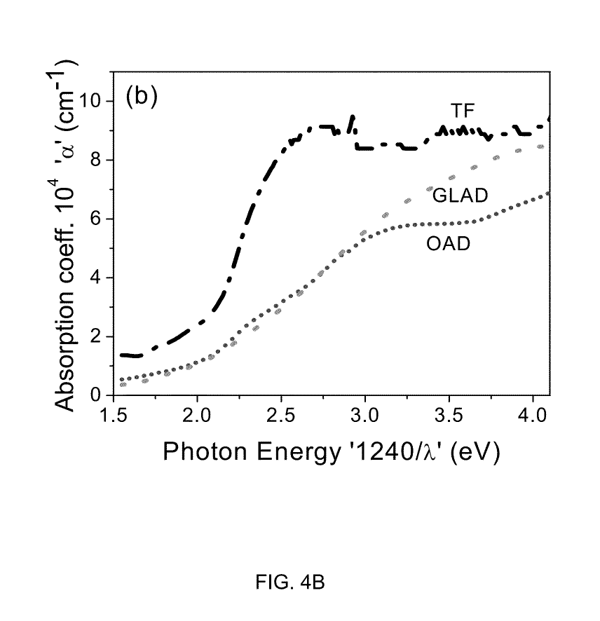

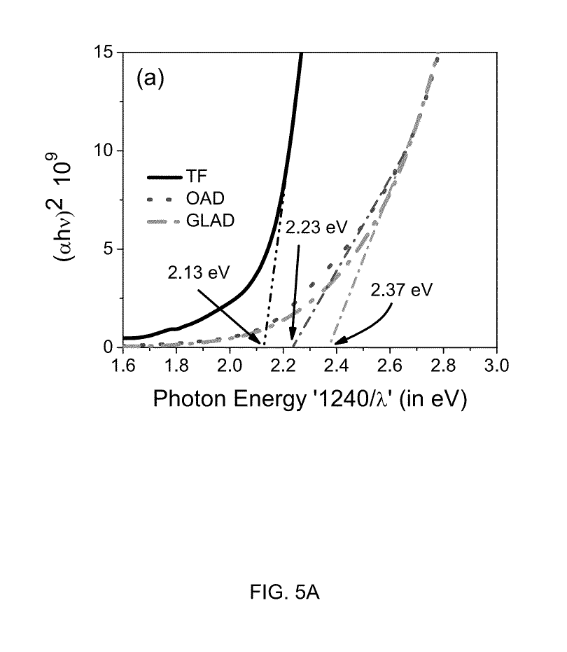

Measure and plot the transmittance T (λ) of the glass-deposited samples in the wavelength range of about 250-850 nm (i.e., for normal incidence using UV/vis JASCO-|V|-570 spectrophotometer; figure not shown here) and calculate absorption coefficient given by: α(λ)=1/t(ln(100/T %). Or, it can also be measured and compared absorbance in the given wavelength region from the diffusive reflectance measurements of Si-deposited samples by using SHIMADZU, UV-2450 spectrophotometer. The absorption spectra of the as-deposited samples are shown in FIG. 4; the spectra of annealed samples are not shown here.

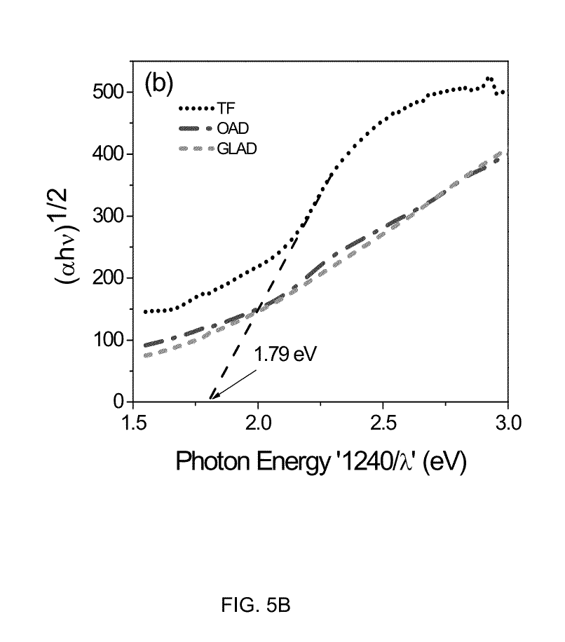

Using αhυ∝(hυ−_{Eg})^{m} plot and extrapolation y=0 will give band-gap; the band-gap plot for as-deposited Fe₂O₃ samples are in FIG. 5 (for annealed samples, the band-gap plots are not shown here to compare the results).

The absorption cut-off wavelengths of the as-deposited Fe₂O₃ samples showed that they can absorb both the UV and V is light significantly (300≦λ≦650 nm) as shown in FIG. 4A. In order to see/compare these results, the absorption coefficient (cm⁻¹) of the samples was plotted as a function of incident photon energy ‘1240/λeV’ (shown in FIG. 4B); a sharp absorption peak appeared at about 620 nm wavelength (the corresponding band gap ‘E_{g}’˜2.0 eV) for the TF and a little bit off for other samples in the vicinity of that wavelength (comparison has been made in optical band-gap calculation, see Table 5).

Note: to consider effect of annealing on samples the band-gap vs annealing temperature can also be plotted, following the same procedure above.

TABLE 5
Band-gap comparison of Fe₂O₃ samples, deposited on glass-substrates.

| Sample (as-deposited)/vertical | Optical band gap(s) |
|---|---|
| thickness measured from SEM (nm) | Direct(D)/Indirect(I) |
| TF/(1000 ± 2%) nm ? | 1.79(I)-2.13(D) eV |
| OAD/622 ± 49 nm | 2.23 (D) eV |
| GLAD/716 ± 30 nm | 2.37 (D) eV |

### Photocatalytic Activities:

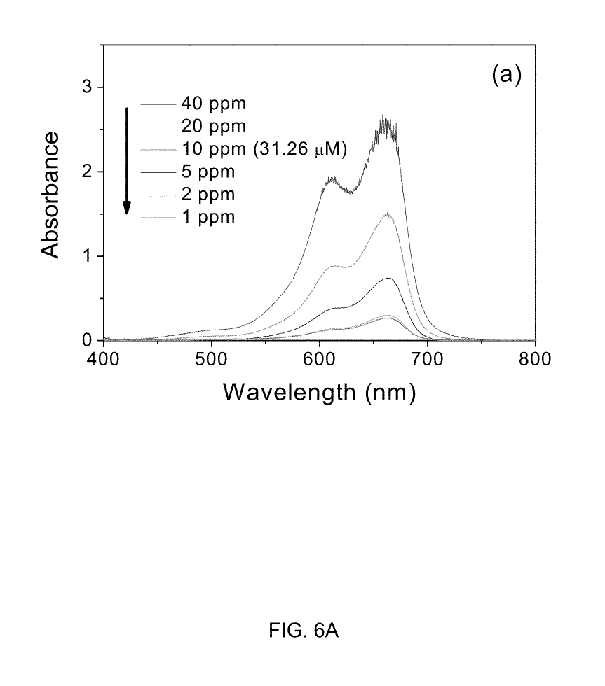

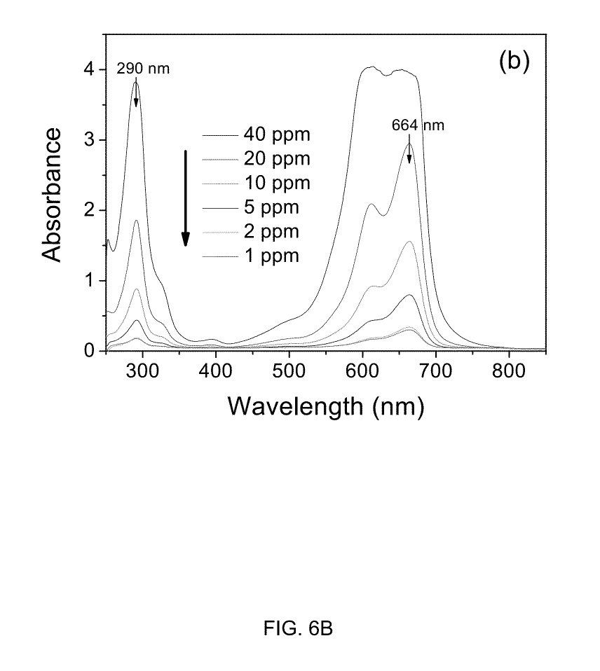

Photocatalytic activity test comparison (to compare decay rates): use Methylene Blue “dye” (MB; C₁₆H₁₈ClN₃S, Alfa aesar) in aqueous solution of initial concentration=10 ppm (=31.26 μM). The main reason to choose this initial concentration has been illustrated in FIG. 6 (i.e., the absorbance spectra recorded by USB-2000 and UV/vis JASCO |V|-570 spectrophotometer for different initial concentrations).

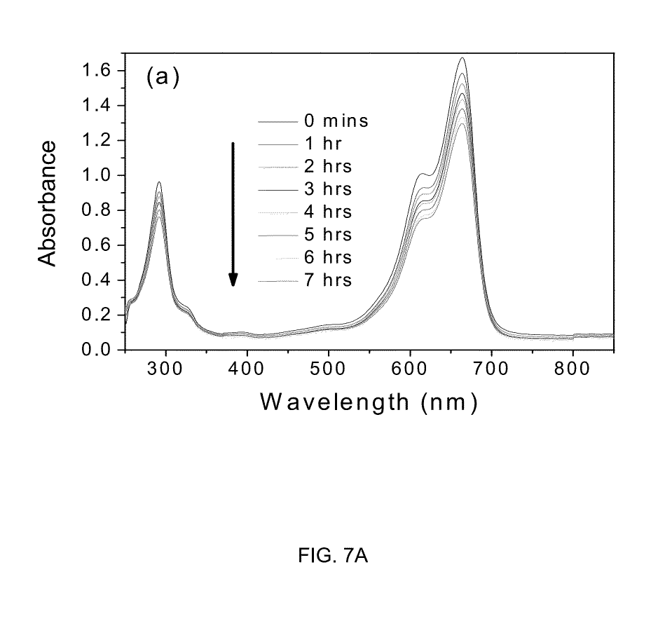

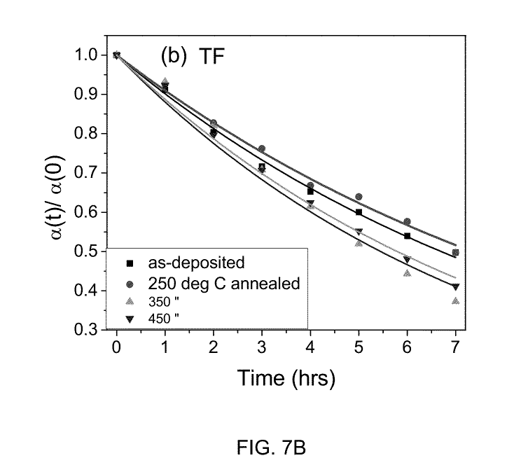

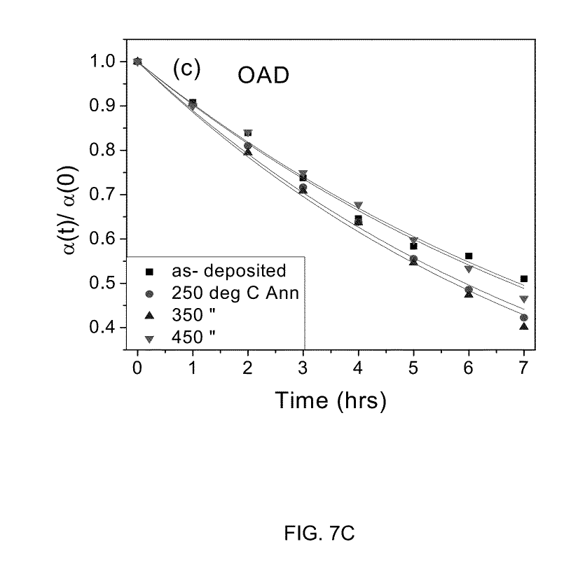

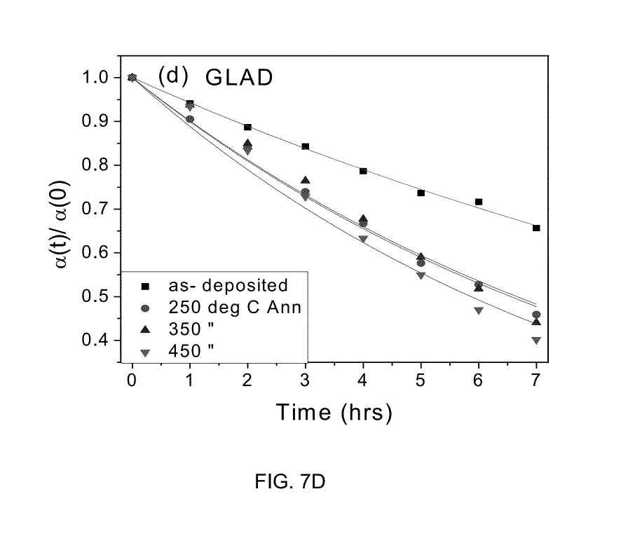

Under the visible light irradiation (using light source of a constant intensity about ≦1.5 AM), record the absorbance spectra of aq MB solution (absorbance peak ˜664 nm, as shown in FIG. 7A) using a photocatalyst (Fe₂O₃ sample) for various time intervals via in-situ measurement by USB-2000. Compare the decay rates obtained from non-linear curve fitting (using pseudo-first order equation given by: α(t)=α(0)exp(−Kt). The normalized absorbance plots, for as-deposited and annealed samples, are shown in FIGS. 7B-D.

Analyze/compare the data based on previous results observed for different morphology (i.e., structure, crystalline size, effective surface area etc.) and optical properties.

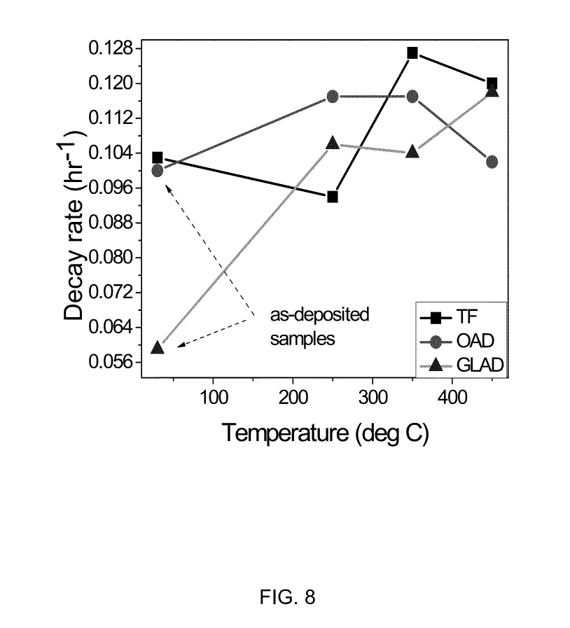

The summary of decay rates comparison for all as-deposited and annealed Fe₂O₃ samples are shown in FIG. 8.

Anti-Bacteria Results:

The efficacy of various FeOX coated samples were tested against a cocktail of E. coli O157:H7. Briefly, E. coli O157: H7 strains 1, 4, 5, 932 and E9 were cultured individually in tryptic soy broth for 24 h. At the end of incubation period, all cultures were sedimented by centrifugation and re-suspended in phosphate buffered saline (PBS). At the end of washing step, 2 ml of each strain was placed in single tube to prepare bacterial cocktail. Appropriate dilutions were made to achieve final concentration of about 10⁷ CFU/ml. To determine efficacy of various FeOX samples, about 0.1 ml of bacterial cocktail was placed on sample and exposed to visible light for set time period (about 30, 60, 120, 180 min). At the end of exposure time, samples were placed in 10 ml washing buffer (0.1% Tween 80+PBS) and vortexted for about 30 s. Bacterial counts were obtained by plating about 0.1 ml of appropriate dilution on tryptic soy agar plates.

For the preliminary study, efficacies of various FeOX samples (Table 6) were tested against E. coli O157:H7 and the results are presented below. The time range was selected as 0 to about 480 minutes with single strain of E. coli (E9) was used.

TABLE 6
Efficacy of various FeOX coated surfaces against E. coli O157:H7

| Sample(s)/as-deposited, or Annealed | Time | |
|---|---|---|
| (annealed at diff temp) | exposure | Log-reduction/ |
| TAD6611-TF as deposited | 300 min | 6 = no survival |
| TAN3507711-TF annealed at 350° C. | 360 min | 6 = no survival |
| TAN4507711-TF annealed at 450° C. | 60 min | 0.15 |
| TAN5507711-TF annealed at 550° C. | 30 min | 0.10 |
| OAD6911-OAD-as deposited sample | 480 min | 6 = no survival |
| OAN2507711-OAD annealed at 250° C. | 420 min | 6 = no survival |
| OAN4507711-OAD annealed at 450° C. | 240 min | 6 = no survival |
| GAN3507711-GLAD annealed at 350° C. | 0 min | 0 |
| GAN3507711-GLAD annealed at 350 C | 90 min | 0.58 |
| GAN5507711-GLAD annealed at 550° C. | 180 min | 6 = no survival |

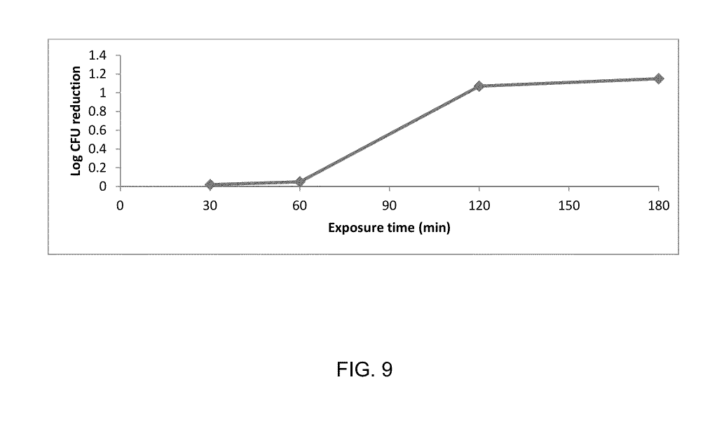

Based on the preliminary results, a FeOx thinfim, FeOX nanoroads as deposited and annealed at about 350° C. were further tested against E. coli O157:H7 cocktail for time periods of about 0, 60, 120 and 180 min. FeOX thin films were effective in reducing E. coli O157:H7 that was inoculated onto the samples at about 6 log cfu/ml concentration. Initial about 60 minute treatment yielded significant pathogen load reductions compared to non-coated glass slide controls. However, about 1.15 logs CFU/ml (FIG. 9) reduction was achieved at about 180 minutes.

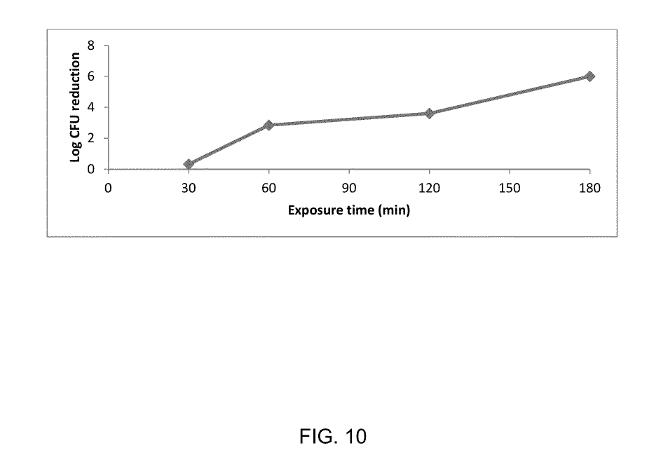

The nanoroad samples annealed at about 350° C. were more effective than the thin film samples. About a 3 log reduction was achieved in the initial 60 min treatment while an about 6 log CFU/ml reduction was achieved by treating the samples for 180 min and bringing the bacterial loads to non-detectable levels (FIG. 10).

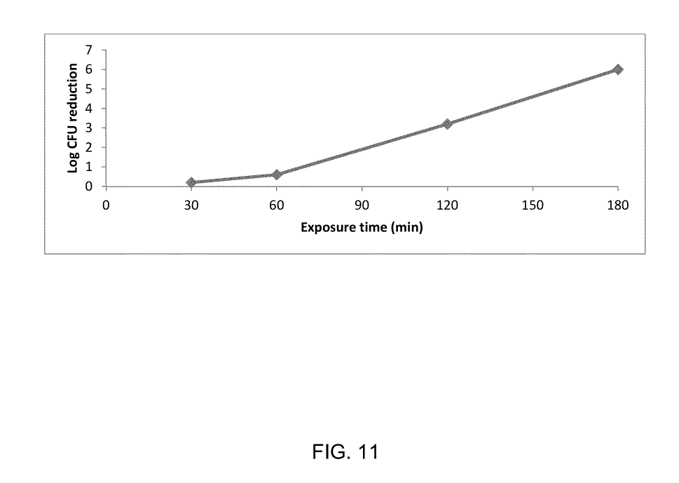

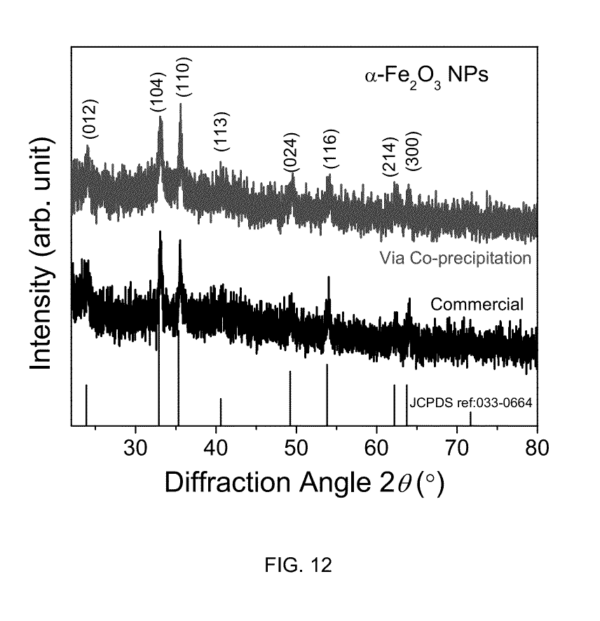

FeOX nanorods as deposited were equally effective as annealed nanorod samples showing a reduction of about 6 log CFU/ml within about 180 min. However, this type of sample achieved more linear reduction over the 180 min exposure time (FIG. 11).

### Example 2

### Fe₂O₃ Nanoparticles (Fe₂O₃ NPs)

Preparation:

The Fe₂O₃ NPs were prepared via Co-precipitation (hydrolytic synthesis route); and reaction follows:

2FeCl₃+3(NH₄)₂CO₃→Fe₂O₃+6NH₄Cl+3CO₂ (1)

Experimental details: Fe₂O₃ NPs by chemical precipitation method (Fe₂O_{3,syn})

### 1) Materials

Iron (III) chloride hexahydrate, 99+%, and ammonium carbonate were used to prepare Fe₂O_{3,syn} NPs. These reagents were purchased from ACROS organics (New Jersey, USA) and used directly as received. De-ionized (DI) water, 18 MΩ, was used in the synthesis of NPs, and also in washing the clusters obtained by centrifuging the as-prepared solution.

### 2) Synthesis of Fe₂O₃NPs

Aqueous solution of FeCl3.6H₂O (0.012 M) was prepared at room temperature by using DI water. The mixture was magnetically stirred about an hour in order to dissolve it completely. Under the vigorous stirring at room temperature, aqueous solution of (NH4)2CO3 (0.3 M) was added drop-wise (about 1 ml/min) until PH value becomes about 7.7. The resulting precipitate was allowed to decant for several hours and the decanted part from the mixture was centrifuged at about 7000 rpm for about 10 minutes. The precipitate was collected and washed several times with the DI water until the chlorine is completely removed. By repeating the above last procedure three times, final product (brown-red color) was separated. The product was dried at about 80° C. for about 30 minutes and calcinated at about 350° C. for about 2 hours.

XRD Results:

The powder samples were characterized by a PANalytical X'Pert PRO MRD X-ray diffractometer (XRD) with fixed incidence angle of about 1.5°. The XRD patterns were recorded with Cu Kα radiation (λ=1.5405980 Å) in the 2θ range from about 20°-80° at step size of about 0.014°. The crystalline size was compared from the most intense peak in the XRD patterns.

TEM Results:

As prepared Fe₂O₃ NPs were diluted enough before using into the TEM grid (i.e., about 100 fold of the initial concentration of about 5 mg/ml). The Fe₂O₃ NPs suspensions were sonicated about an hour before every measurement. Two types of samples were prepared for TEM analysis, i.e., by starting with the NPs suspensions shaking before the sonication and taking only the top part of solution without shaking it after more than about 2 weeks from the preparation date.

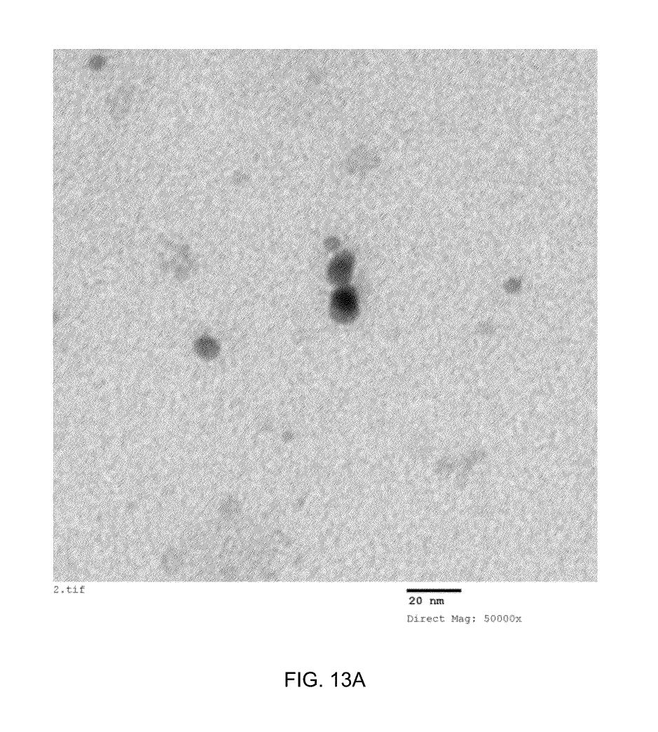

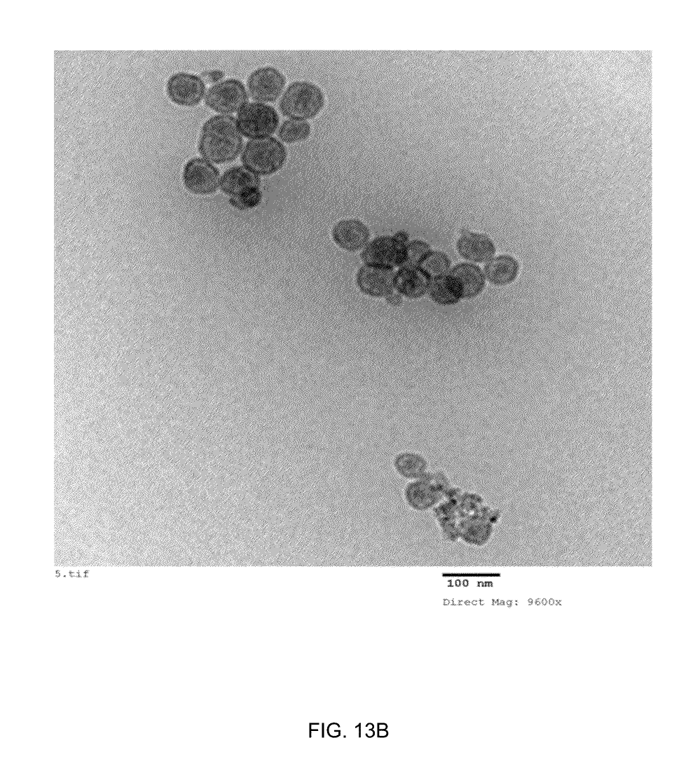

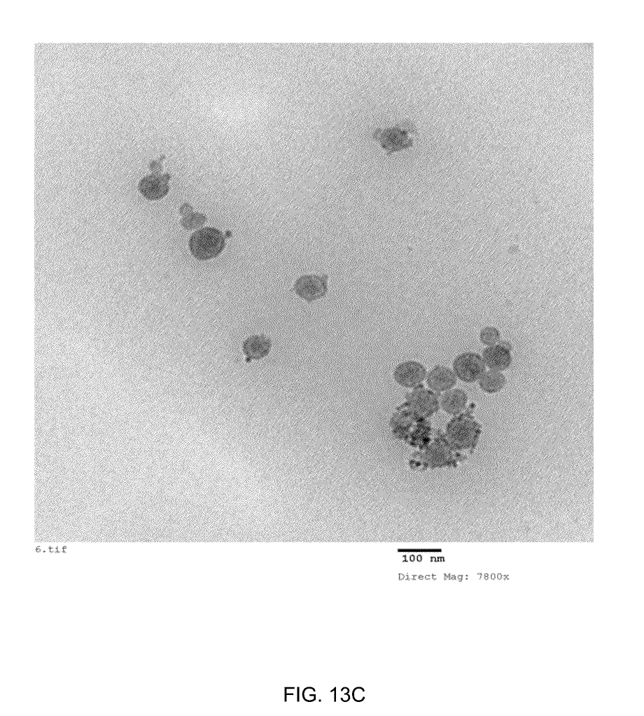

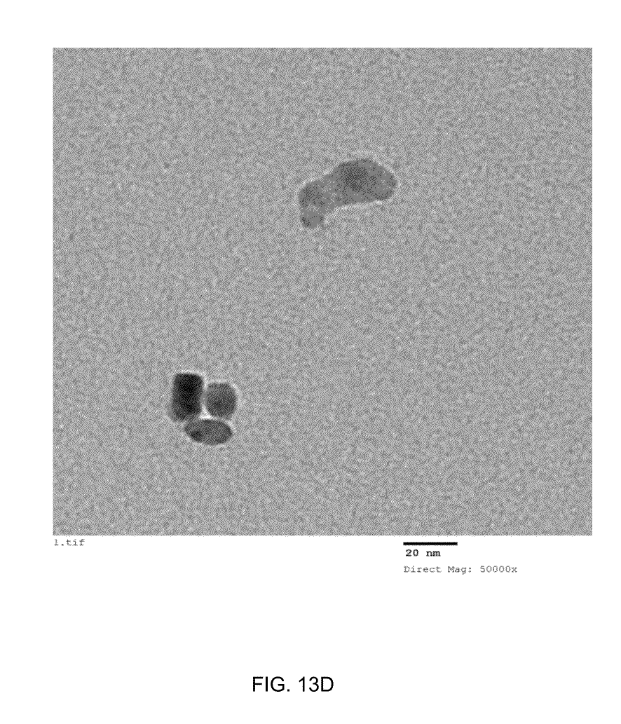

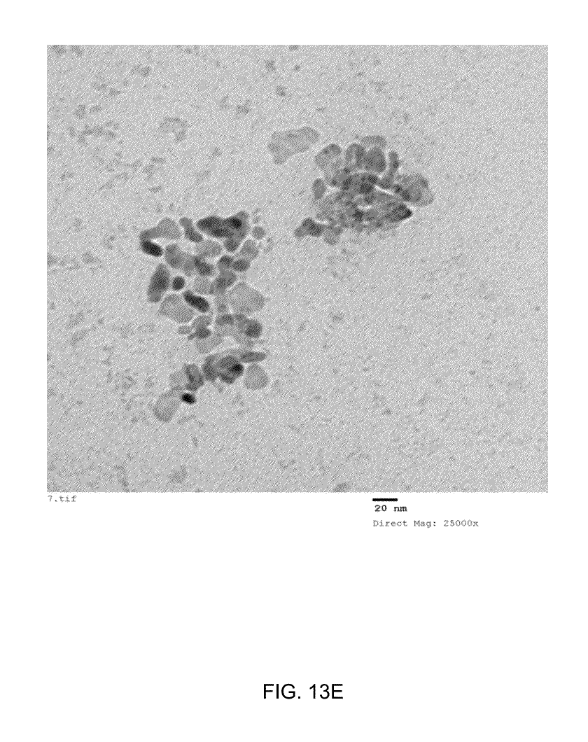

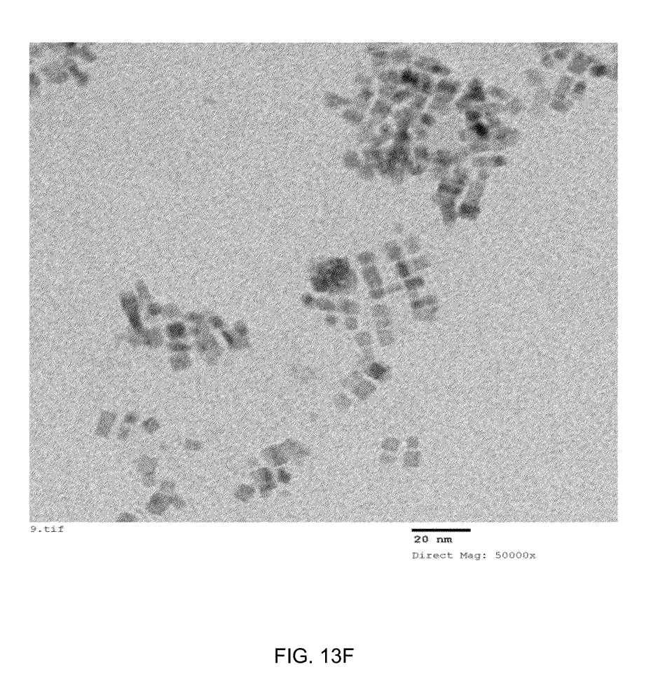

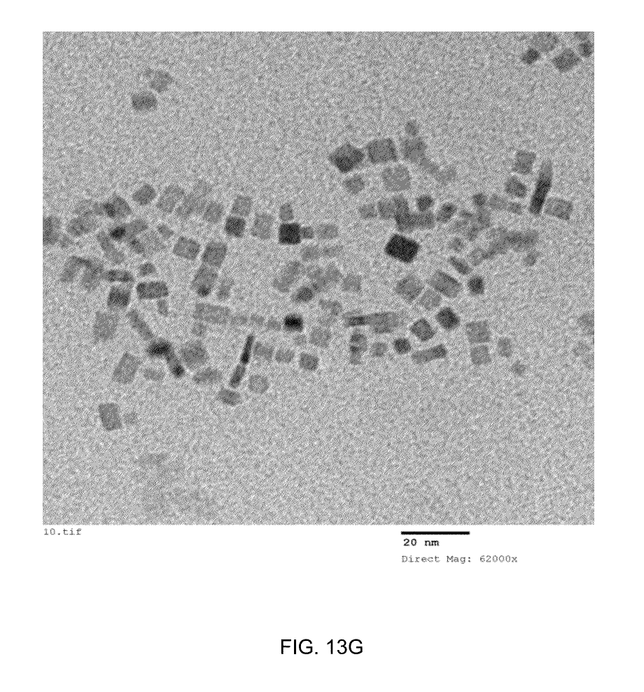

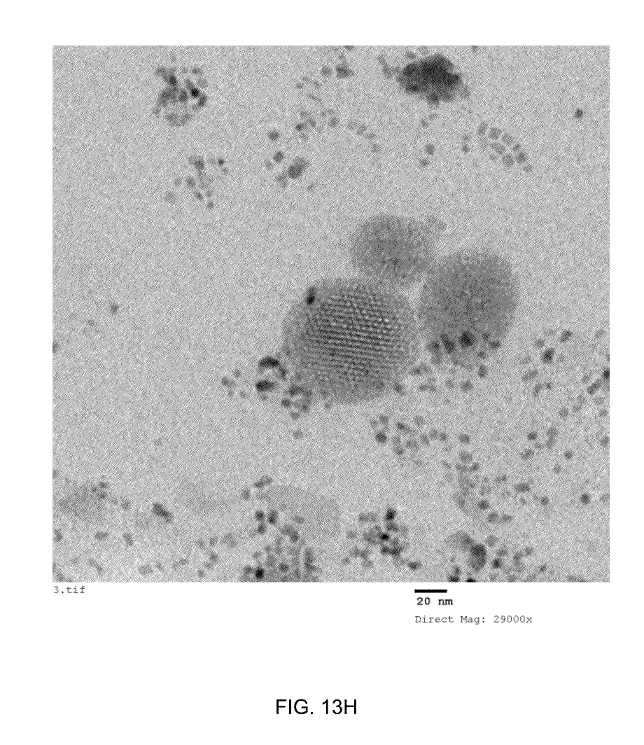

With reference to FIGS. 13A-13H, NPs were of both spherical and cubical shapes; and cubical NPs, those are square in 2D, were the smaller in size and spherical were bigger. The distributions of NPs sizes were relatively bigger, for example, spherical NPs (about 20-80 nm) than cubical (of side=about 10±3 nm with few exceptions).

With regard to the square size, likely represent the smaller particles, so looks like just beginning to grow (however, there are few small particles as well; and are very nice spherical shape of about 50 nm size).

Few particles were observed to be connected together; and forms like a rod shaped (or slightly larger particles) are present.

DLS Results:

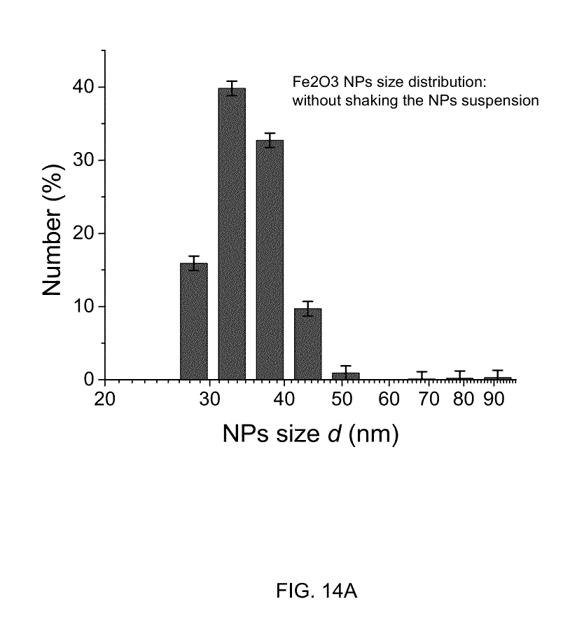

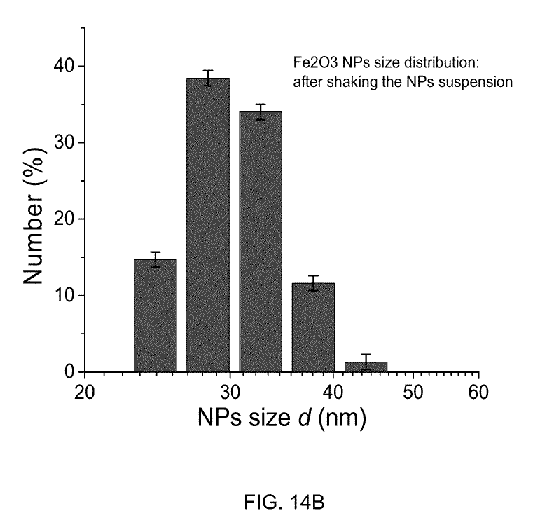

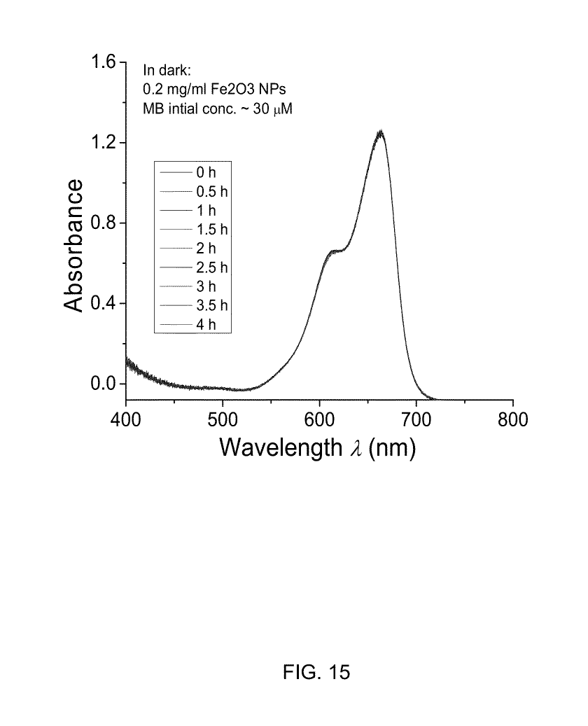

With reference to FIGS. 14A-14B, average NPs size: about 25-43 nm. Aggregation were observed (even shaking the Cuvette results a slight change in NPs size, FIG. 14B).

Photocatalytic Degradation:

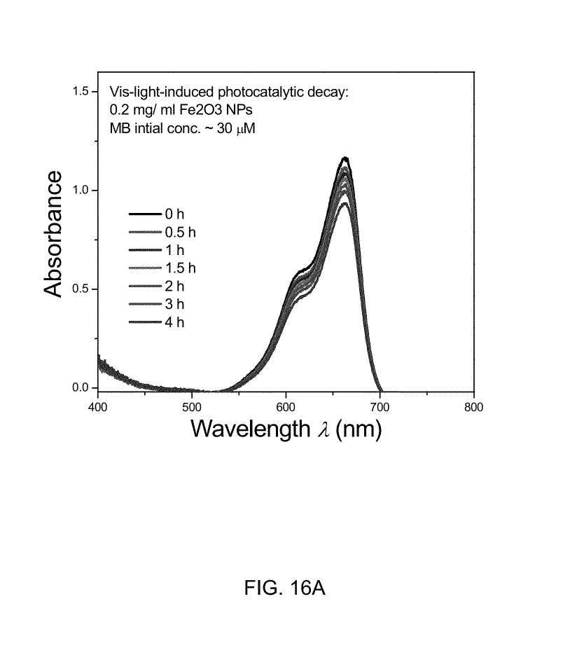

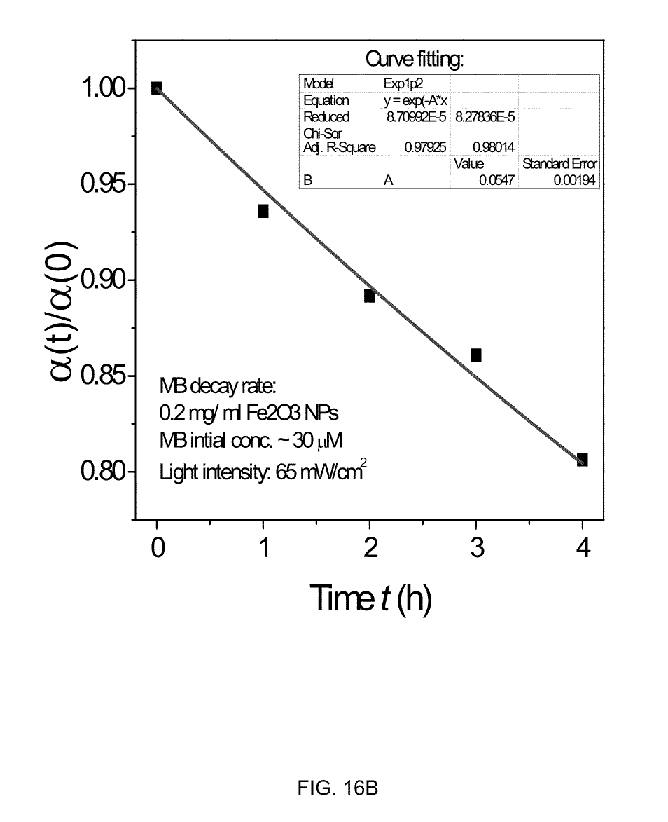

In dark, NO decay were observed for Methylene Blue (MB, of initial concentration about 30 uM). Under Visible light irradiation, MB degradation were observed (FIGS. 16A-16B).

Antimicrobial Activity:

The antimicrobial experiments were performed under the following conditions:

Light intensity: about 65 mw/cm² (UTILITECH halogen lamp); Initial bacterial (e.g., E. coli surrogate strain 1427) concentration: about 10⁸ CFU/ml; Reaction mixture volume: about 30 ml (about 27 ml NPs suspension+about 3 ml bacterial suspension).

No log reductions were observed with prepared, α-Fe₂O₃ NPs; and the result is tabulated below in Table 1:

TABLE 1

| | |
|---|---|
| Time (min) | Log |

| | 30 | 60 | 90 | 120 | Reduction* |
|---|---|---|---|---|---|
| Control | 8.24 | 8.02 | 8.21 | 8.08 | |
| 1 (1 mg/ml) | 8.04 | 8.05 | 8.11 | 8.16 | ~0 |
| 2 (1 mg/ml) | 7.99 | 8.13 | 8.16 | 8.17 | ~0 |
| 3 (1 mg/ml) | 8.07 | 8.16 | 8.18 | 8.19 | ~0 |

*The values were expressed in log CFU/ml

### Example 3

Both Fe₂O₃ thin films and nanorod arrays are deposited using electron beam evaporation through normal thin film deposition and oblique angle deposition (OAD) and are characterized structurally, optically, and photocatalytically. The morphologies of the thin films are found to be arrays of very thin and closely-packed columnar structures, while the OAD films are well-aligned nanorod arrays. All films were determined to be in the hematite phase (α-Fe₂O₃), as confirmed by both structural and optical characterization. Texture measurements indicate that films have similar growth modes where the [110] direction aligns with the direction of material growth. Under visible light illumination, the thin film samples were more efficient at photocatalytically degrading methylene blue, while the nanorod arrays were more efficient at inactivating E. coli O157:H7. The size of the targeted agent and the different film morphologies result in different reactant/surface interactions, which is the main factor that determines photoactivity. Furthermore, an analytic mathematical model of bacterial inactivation based on chemotactic bacterial diffusion and surface deactivation is developed to quantify and compare the inactivation rate of the samples. These results indicate that α-Fe₂O₃ nanorods are candidates for antimicrobial applications and are expected to provide insight into the development of better visible-light antimicrobial materials for food products and processing environments, as well as other related applications.

### Introduction

Escherichia coli O157:H7 is a well-known food borne pathogen, responsible for 73,000 illnesses annually and costs the United States approximately $405 million in medical expenses.¹ E. coli O157:H7 infection often leads to bloody diarrhea and hemolytic uremic syndrome (HUS).² This pathogen is naturally present in the intestinal tract of cattle; hence the contamination of beef products with bovine feces is primary source of E. coli O157:H7.³ Besides direct contact with bovine feces, beef products can be contaminated with E. coli O157:H7 by coming in contact with contaminated beef processing equipment.⁴ Microbial contamination is a serious issue within the food industry. Therefore, there is an urgent need to develop effective antimicrobial agents to help eliminate this pathogen and control its spread in ground beef and beef-processing environments.

The antibacterial agents currently used in the food industry can be classified into two categories: organic and inorganic. The key advantages of inorganic antimicrobial agents over their organic counterparts are improved safety and stability at high temperatures and pressures.^{5,6} Therefore, the use of inorganic antimicrobial agents to treat food processing equipment and other food contact surfaces to reduce the chances of cross-contamination has attracted a lot of attention.^{5,7} In particular, photo-activated antimicrobial nanostructures are especially interesting.^{6,8,9} These photocatalysts include various oxide semiconducting materials, their metal hybrid nanocomposites, and doped structures such as, TiO₂, ZnO, CuO, MgO, Ag/TiO₂, TiO₂/CuO, TiO₂/Pt, Au/TiO₂, Fe₂O₃/TiO₂, and N—, C—, S— doped TiO₂.^{5,6,8-12} Inorganic materials can be used in different forms such as powders, coated on cellulose fibers, or as part of an inorganic/organic nanocomposite coating,⁵ and they have been successful in inactivating a wide range of Gram-positive and Gram-negative bacteria.¹³

The dynamics and mechanism of E. coli inactivation using photocatalysts under UV, visible light, and solar simulated irradiation have been reported by various studies.^{7-9,14}, It is believed that the bactericidal effect/killing action is initiated by the photochemical oxidation of intracellular coenzyme A, which alters the respiratory activities.^{10,15} However, there is also more direct evidence that the lethal action is due to outer membrane and cell wall damage. This is mainly due to the production of reactive oxygen species (ROS) such as hydroxyl radicals (.OH) and hydrogen peroxide (H₂O₂) by the photocatalysts under illumination, and can induce phospholipid peroxidation and ultimately lead to cell death.¹⁴

Of the inorganic antimicrobial agents, TiO₂ is the most common material used for biocidal application since its first introduction by Matsunaga et al., in 1985. However, the practical use of TiO₂ nanostructures as a photocatalyst and bactericidal material is limited due to its large band-gap (E_{g}=3.2 eV, λ_{g}=388 nm).¹¹ This means that TiO₂ photocatalysis is generally unproductive under visible light illumination and can utilize no more than about 2-3% of the incoming solar energyl² or requires a special UV light source, which is generally harmful to humans. Recently, hematite (α-Fe₂O₃) has attracted a lot of attention for photocatalytic applications due to its ability to absorb a large part of the solar spectrum (E_{g}=2.2 eV, λ=564 nm), its chemical stability (stable through a large PH range), non-toxicity, abundance, and low cost.^{16,17} However, α-Fe₂O₃ has not attracted any attention for bactericidal applications, which is surprising because α-Fe₂O₃ materials have already been approved by the Food and Drug Administration (FDA) for food and medical applications. Thus, an investigation of the photocatalytic and bactericidal properties of α-Fe₂O₃ is necessary.

Various methods have been applied to synthesize α-Fe₂O₃ nanostructures, and the photocatalytic behavior of α-Fe₂O₃ is strongly dependent on fabrication methods.¹⁸ Physical vapor deposition (PVD) can produce uniform nanostructured thin films, in which the size and geometry can be controlled precisely, and has proven to be a successful method of fabricating uniform, efficient photocatalysts.^{19,20} Oblique angle deposition (OAD) is a PVD technique in which the incident material vapor is directed toward a substrate at large incident angles (greater than about 70°), resulting in the self-organized formation of tilted nanorod arrays due to the shadowing effect.²¹⁻²³ Generally, the nanorods produced by OAD are tilted toward the direction of vapor flux. The present disclosure shows that the photocatalytic behavior of materials depends strongly on morphology of the nanorod arrays, which can be varied by adjusting the deposition parameters.¹⁹

In this study, both Fe₂O₃ thin films and Fe₂O₃ OAD nanorod arrays are deposited using electron beam evaporation and are characterized structurally and optically, and are further tested for photocatalytic and antimicrobial applications. The morphologies of the thin films are found to be arrays of very thin and closely-packed columnar structures with prismatic ends, while the OAD films are well-aligned nanorod arrays. All films were determined to be in an oriented α-Fe₂O₃ phase by X-ray diffraction and Raman spectroscopy. The optical properties of the films are found to be consistent with porous α-Fe₂O₃. The thin films are more photocatalytically active than the nanorod arrays for methylene blue degradation under visible light irradiation, while the nanorod arrays have higher antimicrobial activity under visible light irradiation. The biocidal results are described quantitatively by a mathematical model that is based on chemotactic bacterial diffusion and surface deactivation and are explained qualitatively by the different bacteria adsorption and adherence properties of the two film morphologies, which are especially important parameter for α-Fe₂O₃ films due to slow charge transfer kinetics and the relatively low oxidation potential of α-Fe₂O₃.

Experimental Section

Materials.

The source material, Fe₂O₃ (99.85+%, metal base), was purchased from Alfa Aesar (Ward Hill, Mass.) and was used as received. Both cleaned glass microscope slides (Gold Seal® Catalog No. 3010) and Si (100) wafer (Montco Silicon Technologies Inc.) were used as substrates. High purity Methylene Blue (MB, C₁₆H₁₈ClN₃S, Alfa Aesar) aqueous solution was used for photocatalytic activity measurement.

Sample Preparation.

Fe₂O₃ thin films and nanorods were prepared by a custom designed vacuum deposition system equipped with an electron-beam evaporation source (Torr International, Inc.). The glass substrates were cut into sizes of 9.0 mm×27.0 mm and 20.0 mm×20.0 mm while Si substrates were cut into size 10.0 mm×10.0 mm. Glass substrates were cleaned with a mixture of sulfuric acid (H₂SO₄) and hydrogen peroxide (H₂O₂) solution, in a 4:1 ratio, by boiling about 15 mins and dried with nitrogen (N₂) flow. Si wafers were cleaned in a mixture solution of deionized (DI) water, H₂O₂, and ammonium hydroxide (NH₄OH) in the ratio 5:1:1, boiling for about 15 mins and dried with N₂ flow. Prior to the deposition, the chamber was evacuated to a pressure less than about 1×10⁻⁶ Torr. During the deposition, the pressure was maintained to about ≦4×10⁻⁵ Torr. For the thin film deposition, the vapour incident angle, θ, was set to 0° from the substrate normal. For OAD nanorod growth, the vapour incident angle was set to a large angle, i.e., θ=about 86°. The deposition rate and the deposited thickness were monitored by a quartz crystal microbalance (QCM) positioned directly facing the material vapor flux. The deposition rate was maintained at about 0.12 nm/s. For thin film, the final QCM thicknesses reading was about 1 μm, while for OAD samples the QCM reading was about 2 μm.

After the deposition, some of the as-deposited films and OAD samples were annealed in a quartz tube furnace (Lindberg Blue M Company, Model Number HTF55347C) under ambient conditions at temperatures T=about 250, 350 and 450° C., respectively. During annealing, the heating rate was set to about 5° C. per minute, ramping up to the desired annealing temperature, and the samples were maintained at the final preset temperature for 4 hours.

Characterization.

The samples were characterized by a PANalytical X'Pert PRO MRD X-ray diffractometer (XRD) with fixed incidence angle of 1.5°. The XRD patterns were recorded with Cu Ka radiation (λ=1.5405980 Å) in the 2θ range from about 20°-80° at step size of about 0.014°. Pole figures were measured using an open Eulerian cradle and poly-capillary lens with Δθ=5° Δψ=5°. The OAD nanorod array samples were oriented such that tilting direction was pointed toward the X-ray source at θ=0°, ψ=0° for both the 2θ scans and pole figure measurements. Raman spectroscopy measurements were recorded using a Bruker Senterra Raman microscope, by exciting the samples with a 532 nm wavelength laser at room temperature, with an about 10 sec exposure time and about 1 mW power. The morphologies of the samples were examined by a field-emission scanning electron microscope (SEM) equipped with an energy dispersive X-ray spectroscopy (FEI Inspect F). The optical properties of the samples were measured by a double beam UV-visible light (UV-vis) spectrophotometer (JASCO V-570) over a wavelength range from about 200 to 800 nm.

The photocatalytic activities of the samples were evaluated by the photocatalytic degradation of a 10 ppm methylene blue (MB) aqueous solution (PH value ˜6.2) under visible light irradiation. The samples on glass substrates were placed into a 10 mm×10 mm×45 mm clear methacrylate cuvette filled with 4.0 ml of MB solution. The cuvettes were illuminated by a 250 W quartz halogen lamp (UtiliTech) covering wavelength range from about 400 to 800 nm. The incident light intensity on sample was kept constant at about 65 mW/cm² as measured by an optical power meter (Thorlabs PM100D/S310C). A rectangular mask (2.4 cm²) was placed in front of the Fe₂O₃ samples to keep the light power the same for all samples during the photodecay measurements. A water filter was placed in front of the cuvette to absorb the IR light. The photodegradation the MB solution were measured by examining the in-situ UV-Vis transmission spectra of the MB solution using an Ocean Optics spectrophotometer (USB 2000). The time evolution of the absorbance peak at λ=664 nm was used to calculate the photodecay rate.

Bacterial Cultures.

Five strains of E. coli O157:H7, E009 (beef), E0122 (cattle), O157-1 (beef), O157-4 (Human) and O157-5 (Human) were used in this study. Strains O157-1 and O157-5 are genetically diverse and from different sources, while other strains were used in numerous previous studies.²⁴⁻²⁶ All bacterial strains were stored at −70° C. in tryptic soy broth (TSB) (Difco, Becton Dickinson, Sparks, Md.) containing 20% glycerol. Prior to experiment, cultures were activated at least twice by growing them overnight in 10 ml TSB at 37° C. Cultures were then sedimented three times by centrifugation (4,000×g for 15 min) and the pellets were re-suspended in phosphate buffered saline (PBS, pH=7). At the end of centrifugation, appropriate dilutions were made to achieve final concentration of 10⁷ CFU/ml. A bacterial cocktail was prepared by adding 5 ml of each strain to a sterile 50 ml tube. The bacterial population of the cocktail was determined by plating 0.1 ml of the appropriate serial dilution on tryptic soy agar (TSA) (Difco, Becton Dickinson, Sparks, Md.). Plates were incubated at 37° C. for 24 hours before enumeration.

Antimicrobial Efficacy Test.

Fe₂O₃ thin films and nanorods were sanitized by exposing to a 30 W UV light (Osram Sylvania lighting Inc., Danvers, Mass.) for 30 min in a biological safety cabinet (Class II Type A/B3, NuAire, Inc., Plymouth, Minn.). 100 μl of the bacterial cocktail was pipetted onto the surfaces of the Fe₂O₃ samples. The antibacterial experiments were carried out in cardboard enclosure at room temperature using a fluorescent light (Model 13 equipped with F13T5 lamps, StockerYale Inc, Salem, N.H.). The distance between light source and sample surface was set to be 17 cm in order to keep the intensity fixed at 10 mW/cm². At the end of 30, 60, 120, and 180 min light exposures, bacteria from samples were recovered by placing samples in 10 ml PBS+0.1% Tween 80 buffer and vortexing for 30 s. Bacterial enumeration was carried out by plating 100 μl suspension on TSA and Sorbitol MacConkey agar (SMAC) (Difco, Becton Dickinson, Sparks, Md.) in duplicates. Plates were placed in 37° C. for 24 hours before bacterial enumeration. Two control experiments were performed, one under illumination using uncoated glass substrates, the other in the dark using Fe₂O₃ thin film and nanorod substrates. Neither control experiment exhibited experimentally significant antimicrobial effects.

Results and Discussions

Morphology and Structural Characterization.

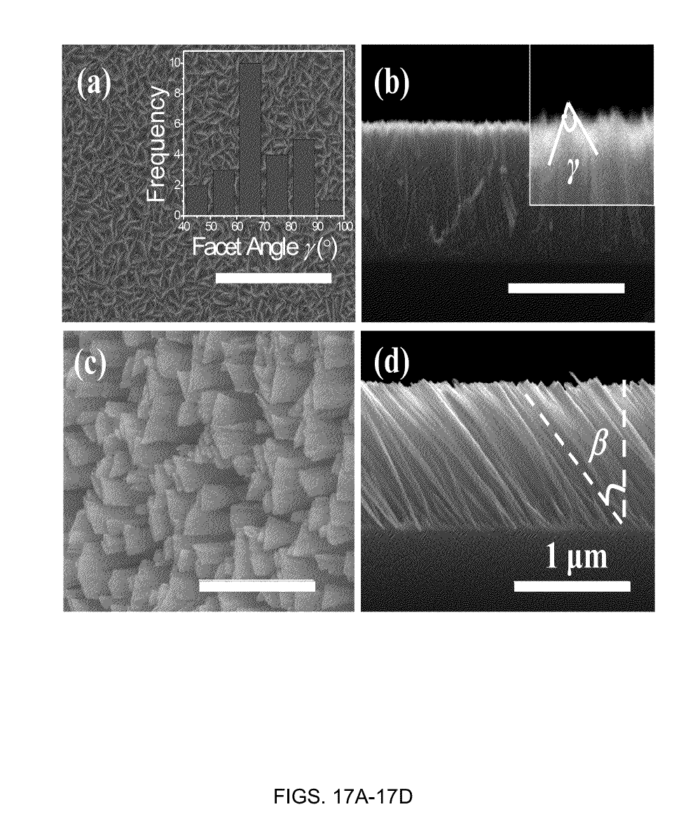

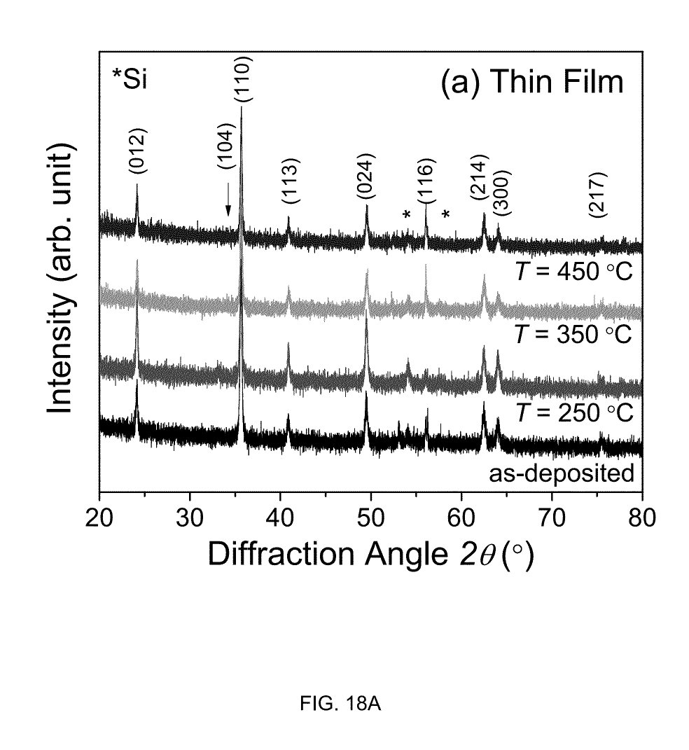

SEM images were collected in order to investigate the morphology of the Fe₂O₃ thin film and nanorod samples. FIGS. 17A and 17B show representative top and cross-section views of a Fe₂O₃ thin film. The top view SEM image shows that the Fe₂O₃ thin films have fine, elongated granular surface features (FIG. 17A), while the cross-section SEM shows that these surface features are the prismatic ends of vertical columnar-like structures (FIG. 17B). As measured from the top view SEM image, the thin edge of the surface grain structures have an average width of about 60±20 nm, and the long edge has an average length of about 140±30 nm. The angles between the prismatic facets, y, on the top surface of the columns are measured from the cross-section SEM image (inset FIG. 17A) and are most frequently found to be between about 60°-70°. The morphology of the thin film is interesting and is the result of the preferred orientation of the polycrystalline grains. This will be discussed in more detail below. The thickness of the thin film is determined to be about 920±20 nm. The morphological parameters of the thin films are consistent for all samples at different annealing temperatures.

FIGS. 17C and 17D show the top and cross-section views of the OAD Fe₂O₃ films, respectively. As expected, the overall morphology of the OAD films is found to be an array of well-aligned tilted nanorods. The nanorods are inclined at angle, β=about 46°±4° with respect to the substrate normal, as indicated in FIG. 17D. This angle is different than the angle predicted by both the Tangent rule (β=½ tan θ)²⁷ and Cosine rule (β=θ−arcsin(1−cos θ/2))²⁸, which respectively predict β≈82° and 58° for the vapor incident angle, θ=86°. Thus, the material dependent model described by Tanto et al. is necessary to explain the tilting angle of the films.^{29,30} They define a material dependent fan-angle, φ, such that:

$$\begin{matrix}for θ \leq φ \text{:} β = θ - arctan [ \frac{sin φ - sin ( φ - 2 θ )}{cos ( φ - 2 θ ) + cos φ + 2} ] , & ( 1 ) \\ for θ \geq φ \text{:} β = θ - φ / 2. & ( 2 )\end{matrix}$$

Although a more thorough study of the tilting angle versus deposition angle for Fe₂O₃ films is necessary for a rigorous result, the measured tilting angle of β=46° for θ=86° suggests that φ=80°. The average thickness of the OAD films is found to be about 1030±20 nm, while the average nanorod length is about 1480±30 nm. The diameter of the nanorod increases along the length of the nanorod, with the fanning out of the diameter being greater in the direction perpendicular to the vapor flux. The average diameter at the top of the nanorods in the direction perpendicular to the vapor flux is about 200±40 nm, as measured from the top view SEM image. The average diameters of the nanorods in the direction parallel with the vapor flux is 50±10 nm at the bottom, 60±10 nm at the middle, and 80±10 nm at the top, as measured from the cross-section SEM image. The nanorod density (η) was found to be approximately 10±2 rods/μm². Using these parameters, the porosities of the OAD films are estimated to be greater than about 64%.

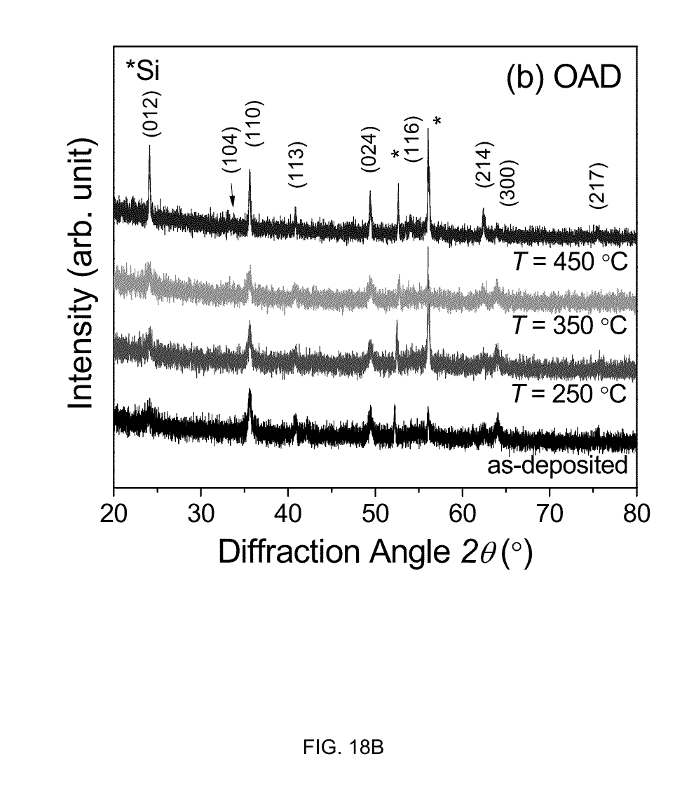

XRD measurements were taken in order to determine the crystalline phase of the samples. FIGS. 18A and 18B show the XRD patterns of the as-deposited and annealed Fe₂O₃ thin films and nanorods. Both the thin films and nanorods are observed to have similar diffraction peak positions, which, as indicated in FIGS. 18A and 18B, correspond with either the peaks listed for the standard powder diffraction of rhombohedral α-Fe₂O₃ (JPCDS No. 00-033-0664) or with peaks associated with the Si substrate. Thus, all of the films are in the hematite phase. For the thin films, the peak intensities and widths remain mostly constant across annealing temperatures, indicating that the as-deposited films are primarily polycrystalline α-Fe₂O₃ with a negligible amount of amorphous regions. For the nanorods, the XRD peak intensities and widths remain mostly constant for annealing temperatures T ≦about 350° C., but at T=about 450° C., a moderate amount of peak sharpening is observed. This peak sharpening is not likely due to grain coarsening since coarsening is not seen in the thin films where it is more energetically favorable.³¹ Thus, the peak sharpening indicates that the as-deposited OAD films are polycrystalline α-Fe₂O₃ but still contain amorphous regions, and after annealing at T=about 450° C., these amorphous regions begin to transition into the α-Fe₂O₃ phase.

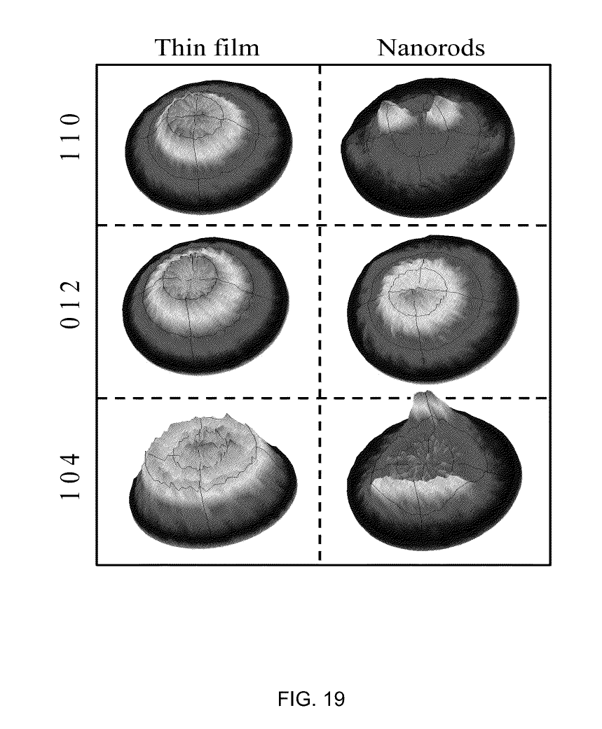

In order to quantify the behavior of crystallite growth, the average grain sizes of α-Fe₂O₃ crystallites for the samples are estimated using the Scherrer equation for the (110) and (012) crystal plane reflections and are listed in Table 1 (below). The average crystallite size of the thin films are in the range of about 42-53 nm in the [110] direction (note that all crystal orientations are written in the hexagonal {hkl} notation, omitting the redundant index i). The estimated crystal sizes in the direction perpendicular to the {012} planes are larger than in the [110] direction and are about 83 nm for the as-deposited and T=about 450° C. samples and about 69 nm for the T=about 250° C. and T=about 350° C. samples. The apparent lack of relationship between annealing temperature and crystallite size agrees well with the supposition that there is a negligible amount of amorphous region in the thin films to feed further grain growth at the higher annealing temperatures. The fluctuations in crystallite size for the different samples could be related to the local environment of the substrate during film growth. The average crystallite sizes of the nanorods are generally smaller than those of the thin films; they are between about 30-47 nm in the [110] direction and about 17-52 nm perpendicular to the {012} planes (Table 1). Aside from the T=about 350° C. sample, the crystallite size generally increases with annealing temperature, suggesting that there is grain growth occurring through an amorphous to α-Fe₂O₃ transition. The smaller crystallite size in the T=about 350° C. sample could be the result of the local environment of that sample during film growth, and that larger grain growth is limited by the absence coarsening for temperatures T ≦about 450° C. As mentioned above, the columnar structures and prismatic facets observed in the SEM images of the thin films suggest that the Fe₂O₃ exhibits a preferential growth direction. In the standard powder diffraction pattern of α-Fe₂O₃, the (104) crystal plane reflection is the most intense, but this reflection is not observed in the XRD spectra of the OAD and thin films. Instead, the most intense reflection for both sets of films, except for the OAD film annealed at T=about 450° C., is the (110) reflection. In order to better understand the crystallite orientations of the films, the XRD pole figures for the (110), (012), and the (104) reflections were measured for both the thin films and nanorods deposited on glass substrates and annealed at T=about 350° C. (FIG. 19). Note that the pole figures have not been corrected for background or defocusing. For the thin film, there appears to be a more intense region from ψ=0°-30° in all pole figures (FIG. 19), which could be due to the background, defocusing, or to a changing orientation as film growth develops. However, it is clear that the (110) pole is centered over ψ=0°, the (012) pole forms a ring around ψ=32°, and the (104) pole figure has an intensity maximum at ψ=54°. These positions are consistent with the [110] growth direction of α-Fe₂O₃, which would orient the poles of (110), (012), and (104) at ψ=0°, ψ=36°, and ψ=56°, respectively. The [110] growth direction is likely responsible for the morphological parameters of the thin films seen in the SEM images. This can be seen in the columnar structures, as the {001} plane is normal to the substrate and is also a cleavage plane of α-Fe₂O₃. The width and length of the prismatic surface features are 56±21 nm and 138±33 nm, respectively and scale with the length of the unit axes of α-Fe₂O₃, which are a=5.04 Å and c=13.76 Å. The angles between the exposed facets of the prismatic columnar tips are found to be primarily between y=60°-70°, which matches well with the inner angle, 60°, between the {110} planes in α-Fe₂O₃.

The pole figures for the (110), (012), and the (104) reflections of the OAD nanorods are shown in FIG. 19. The (110) poles of the nanorods are centered over ψ=35°, the (012) poles are centered over ψ=10°, and the (104) poles are centered over ψ=47° and ψ=73°. The orientation of the [110] direction in the nanorods is tilted away from the substrate normal at ψ=35°, but it is not fully aligned with the material growth direction, which is at β=46°. While the [110] directions of the thin and OAD films are oriented differently relative to the substrate, both appear to be influenced by the direction of material growth. However, the slight misalignment between the material growth direction and the [110] direction might contribute to the greater amorphization of the nanorods compared to the thin films. Material growth in the [110] direction for both films could be the result of oxygen deficiency in the incoming vapor flux. The [110] direction is Fe-rich, and the {110} planes are relatively Fe-deficient³² and have among the lowest surface energies of the main faces of α-Fe₂O₃ crystallites.³³

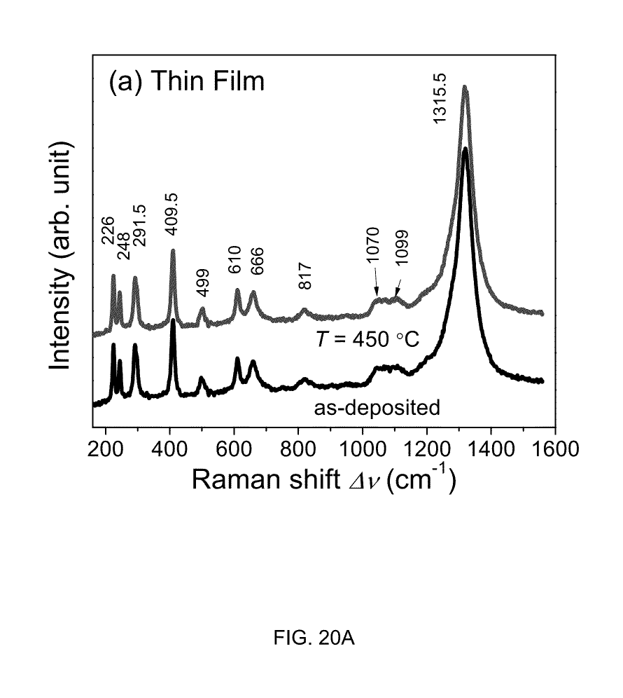

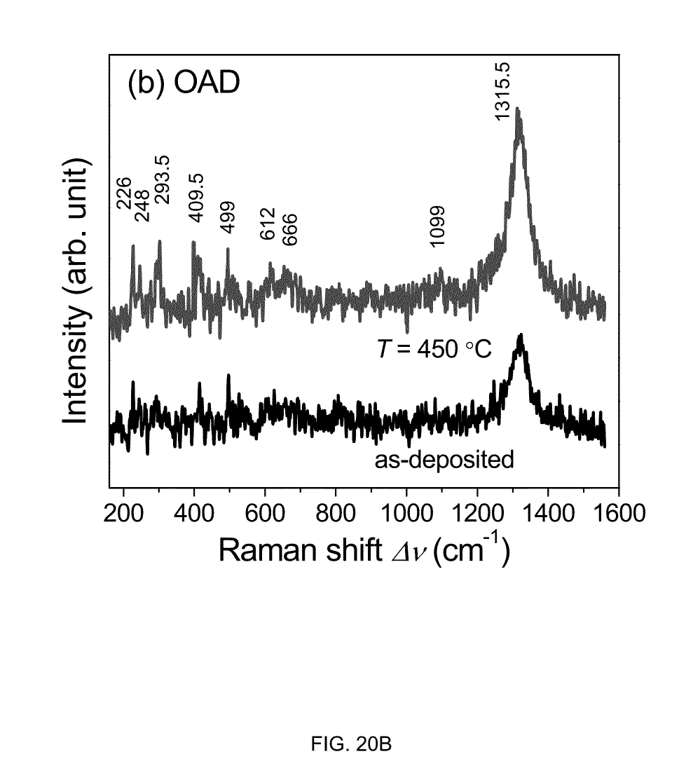

In order to further confirm crystal phases of the Fe₂O₃ films, Raman spectroscopy measurements were carried out for both the as-deposited and the T=about 450° C. annealed samples. The measured spectra are shown in FIG. 20. Each spectrum represents the average of three measurements, which were recorded over the detection range from Δv=200-1600 cm⁻¹ at room temperature. Both the thin films and nanorods are observed to have similar peak positions, although there is a greater noise level in the nanorod samples due to the smaller material volume. For both sets of films, the peak positions do not change after annealing at T=about 450° C. Importantly, all of the observed Raman peaks are attributed to α-Fe₂O₃. The peaks at Δv=226, 248, 292, 410, 499, and 610 cm⁻¹ respectively correspond with the A_{1g}, E_{g}, E_{g}, E_{g}, A_{1g}, and E_{g} modes of α-Fe₂O₃.³⁴ The peak at Δv=1316 cm⁻¹ is attributed to a second order phonon mode of α-Fe₂O₃.³⁵ The peak appearing at Δv=666 cm⁻¹ is attributed to an IR mode that that can manifest in the Raman spectra of α-Fe₂O₃ due to the relaxation of Raman selection rules in nanostructured materials.³⁴ The peak at Δv=820 cm⁻¹ agrees well with the predicted Raman shift due to one magnon scattering.³⁶ Finally, the smaller peaks at Δv=1070 and 1099 cm⁻¹ are consistently seen in the Raman spectra of pure α-Fe₂O₃, but are typically unassigned.^{34,37,38} Thus, the Raman spectroscopy measurements confirm the XRD results in showing that the films are purely hematite.

Optical Properties.

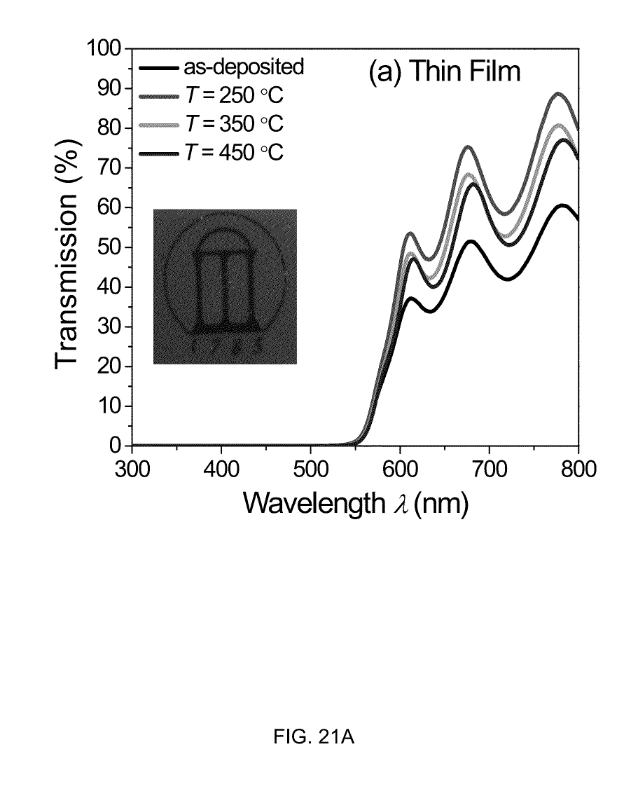

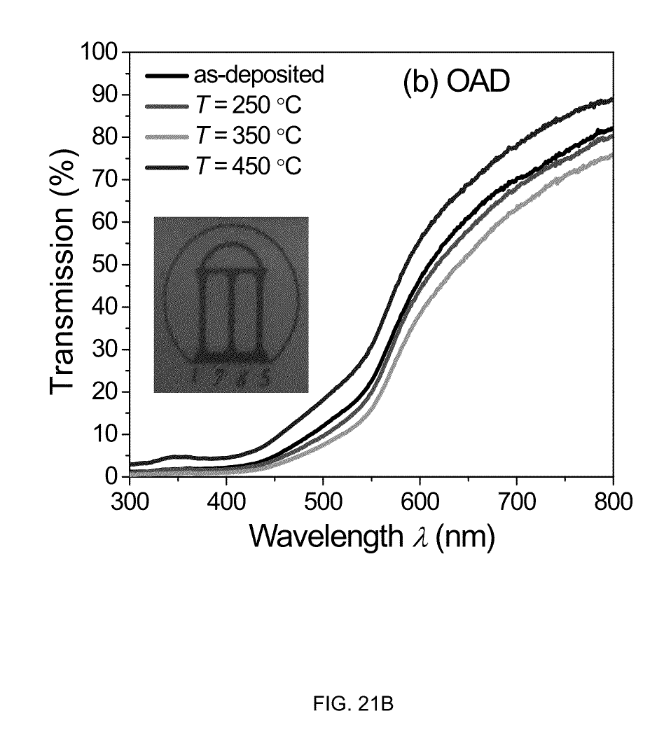

Visual inspection suggests that the appearance of thin films and OAD films are optically similar to α-Fe₂O₃, as both sets of films exhibit the reddish-brown color, typical of hematite (photographic insets FIGS. 21A and 21B). In order to characterize the optical properties of the Fe₂O₃ films, the optical transmission spectra were measured by UV-vis spectroscopy and are shown in FIGS. 21A and 21B. Both sets of films show significant attenuation of visible light beginning around λ=600 nm, with the OAD films being more transparent due to their smaller material volume and larger porosity. The interference fringes seen in the spectra of the thin films are not seen in the OAD films due to decoherence from the broadband diffuse scattering of the nanorods. Using the interference fringes, University of Georgia logo, the refractive index and porosity of the Fe₂O₃ thin films can be estimated via the envelope method.³⁹ The refractive index is calculated using:

$$\begin{matrix}n ( λ ) = {[ N + {( {N}^{2} - {n}_{s}^{2} )}^{1 / 2} ]}^{1 / 2} , & ( 3 ) \\ N ( λ ) = 2 {n}_{s} \frac{{T}_{max} - {T}_{min}}{{T}_{max} {T}_{min}} + \frac{{n}_{s}^{2} + 1}{2} , & ( 4 )\end{matrix}$$

where Tₘₐₓ is the transmission given by the maximum envelope function, Tₘᵢₙ is the transmission given by the minimum envelope function, and nₛ is the refractive index of the substrate (nₛ=1.52, for glass). The film porosity, P, can be estimated from the index of refraction, n, using,⁴⁰

$$P = [ 1 - \frac{{n}^{2} - 1}{{n}_{d}^{2} - 1} ] \times 100 , \qquad ( 5 )$$

where n_{d}=2.87 is the pore-free refractive index of α-Fe₂O₃ at λ=750 nm. The results are summarized in Table 2 (below). As expected, the refractive indices of the thin films are less than the literature value due to the nanocolumnar morphology. The porosities of the thin films vary, with the as-deposited film being the least porous with 28% void and the T=350° C. film being the most porous with 43% void. The porosity of the thin film scales with the estimated crystallite size in the direction perpendicular to the {012} planes and not with the crystallite size in the [110] direction. This observation is consistent with the preferred orientation of the Fe₂O₃ thin films seen in the XRD analysis and with the supposition that the columnar morphology is primarily responsible for the porosity in the thin films. The varying porosities are not expected to be the result of the annealing treatment; instead, they are likely the result of different local environments during film growth.

The optical absorption coefficient α(λ) is calculated, assuming reflection is negligible, from the experimentally measured transmittance data, T(λ), using the relation⁴¹: α(λ)=1/d ln(1/T), where d denotes the film thickness. The absorption coefficient is used to estimate the apparent band gap energy, E_{g}, of the samples utilizing the Tauc relation: (αhv)∝(hv−E_{g})^{1/2}, since α-Fe₂O₃ is a direct band gap material. By plotting (αhv)² versus hv and extrapolating the linear portion of the curve back to the abscissa, the optical band gap can be estimated. The Tauc plot analyses for the Fe₂O₃ thin films and nanorods are summarized in Table 2. For the thin films, E_{g}=2.17-2.21 eV, while for the nanorods E_{g}=2.07-2.11 eV. The band gap energies are similar within each set of samples, but the extrapolated band gaps of the nanorods are less than the thin films. This is likely due to the increased diffuse scattering of the OAD nanorods at longer wavelengths, but also could be attributed to a wider Urbach tail. However, these results agree fairly well with previously reported results for the hematite band gap, E_{g}=2.1-2.7 eV.⁴²⁻⁴⁵

Photocatalytic Activity.

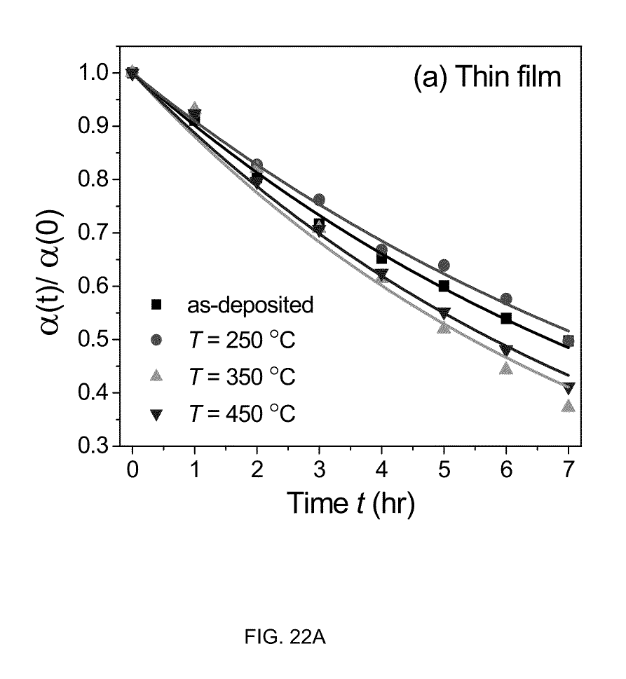

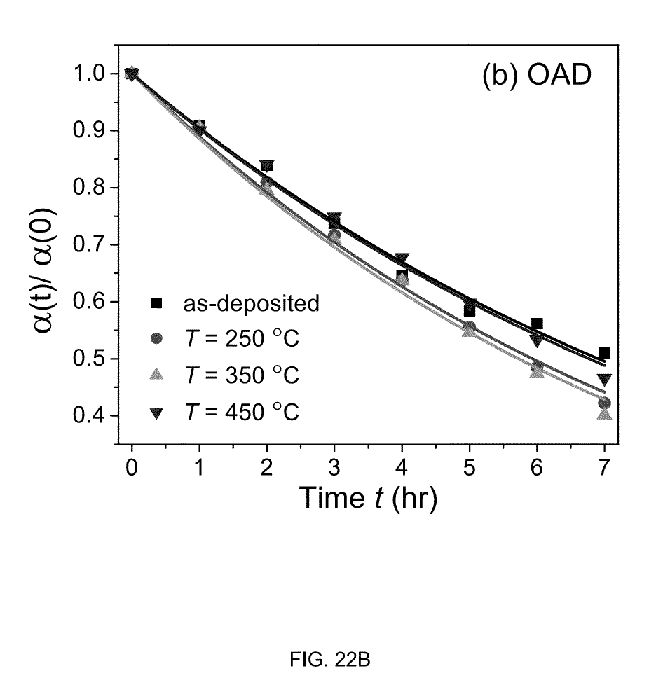

The photocatalytic properties of the Fe₂O₃ thin films and OAD films were characterized using MB photodegradation experiments under visible light illumination. As a control, the absorbance peak of the MB solution was monitored over several hours under two different conditions: (i) with a photocatalyst in the dark and (ii) with a bare glass substrate under visible light illumination. The change in the absorbance peak of MB under these conditions is found to be negligible, indicating that there is no loss of MB without an irradiated photocatalyst. For all Fe₂O₃ samples placed in MB solution and under visible light illumination, the MB absorbance peak is observed to decrease with time, indicating the decomposition of MB (FIG. 22). The change in the intensity of the MB absorbance peak at λ=663.7 nm versus time for all samples exhibits exponential decay behavior. In order to quantify the results, the MB absorbance peak intensity is normalized to the initial absorbance at t=0, and the data are fit to a first-order exponential decay equation,

α(t)=α₀e^{κ}^{_{c}}^{t}, (6)

where αₒ is the initial MB absorbance intensity at t=0 hr., t is time, and κ_{c} is the decay constant. The fitting results are shown in FIG. 22 as solid curves. For the thin films, the samples annealed at the higher temperatures are more efficient photocatalysts, with the sample annealed at T=about 350° C. showing the highest decay rate at κ_{c}=0.052±0.005 hr⁻¹. The slowest decay rate of all samples is the thin film annealed at T=about 250° C., which has a decay rate of κ_{c}=0.039±0.002 hr⁻¹. The decay rates of the nanorods are not a monotonic function of annealing temperature and are similar in value to the decay rates of thin films and range from κ_{c}=0.041-0.048 hr⁻¹. Interestingly, the photodecay rates of the nanorods are slightly smaller than those of the thin films, even though the nanorods have a larger porosity.

Effective photocatalysts are films that exhibit efficient charge transfer to and across the semiconductor-solution interface. The annealing process generally increases crystallite sizes and passivates defects, such as oxygen vacancies, improving charge lifetimes. This is why the catalytic efficiency, for the most part, increases with annealing temperature for both the OAD and thin film samples. However, defects can be beneficial by acting as catalytic hot spots and increasing the conductivity of the material; thus, the removal of too many defects might explain the decrease in catalytic efficiency at the highest annealing temperature for both the OAD and thin films. It is well known that α-Fe₂O₃ has anisotropic charge transport properties. In particular, the conductivity in the [110] direction, or within the (001) plane, is known to be up to four magnitudes higher than in directions orthogonal to it.⁴⁶ Thus, the preferred orientation of the Fe₂O₃, as described above, could create an environment favorable for increased charge separation due to the larger crystalline sizes in the more conductive [110] direction, resulting in less grain boundary scattering and trapping of free charges.

However, in addition to efficient charge transfer within the nanostructure, charge transfer across the nanostructure-solution interface is equally important. As mentioned above, α-Fe₂O₃ is known to have slow kinetics at aqueous interfaces, but specific crystal planes have been found to be more reactive for certain photocatalytic and catalytic reactions. Gao et al. concluded that α-Fe₂O₃ nanorods were more efficient for CO oxidation than α-Fe₂O₃ nanotubes and nanocubes due to their greater area of exposed {110} planes.⁴⁷ Similar results regarding the greater efficiency of {110} planes for CO oxidation have been reported elsewhere in the literature.^{48,49} The explanation for the greater efficiency of {110} planes is that CO adsorbs first to Fe atoms and then is subsequently oxidized by a neighboring surface O atom. Since {110} planes have a large number of surface Fe atoms, more CO is adsorbed and oxidized there.⁵⁰ Similarly, Weiss et al. found that cationic Fe sites on the (001) surface were fundamentally important during the catalytic decomposition of ethylbenzene and styrene due to greater reactant absorbance at these sites, and they postulate a general rule that the chemisorption reactivity of metal-oxides requires the presence of acidic metal sites at the surface.⁵¹ While the photocatalytic and catalytic reactions mentioned above are different than the MB degradation experiment described here, it is clear that reactant adsorption at Fe surface sites is an important factor in determining the efficiency of α-Fe₂O₃ photocatalysts. Adsorption directly to the α-Fe₂O₃ surface is especially important given the slow interfacial kinetics. Furthermore, the reactant must be directly oxidized because the valence band of α-Fe₂O₃ is not sufficiently positive to generate hydroxyl radicals (at pH=7), nor is the conduction band sufficiently negative to generate superoxides,^{52,53} which precludes oxidation at a distance via reactive oxygen species and requires direct contact of the reactant with the surface. Thus, the exposed planes of the Fe₂O₃ thin film, {110} and {001}, provide better absorbance for MB molecules, and this better absorbance is likely the cause of the slightly higher photocatalytic efficiency of the thin films than the OAD films, even though the OAD films are more porous and have a higher surface area.

Antimicrobial Activity.

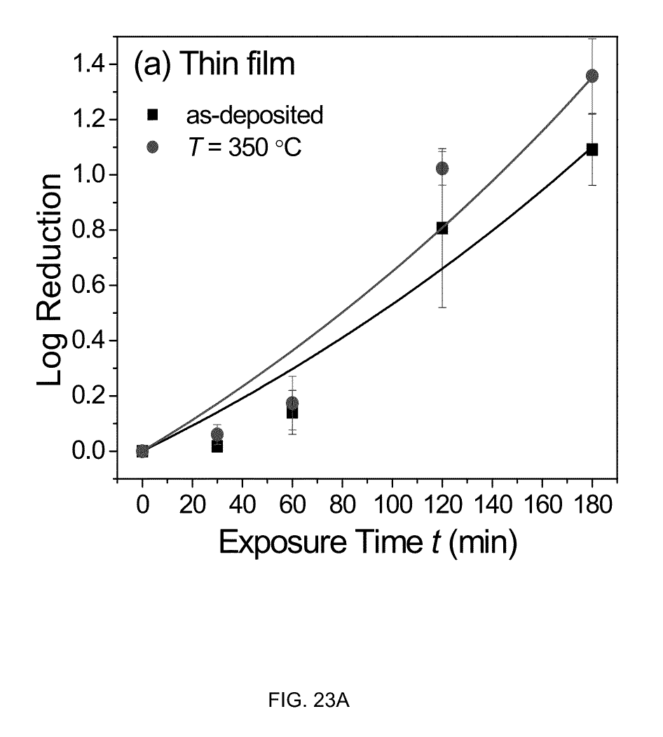

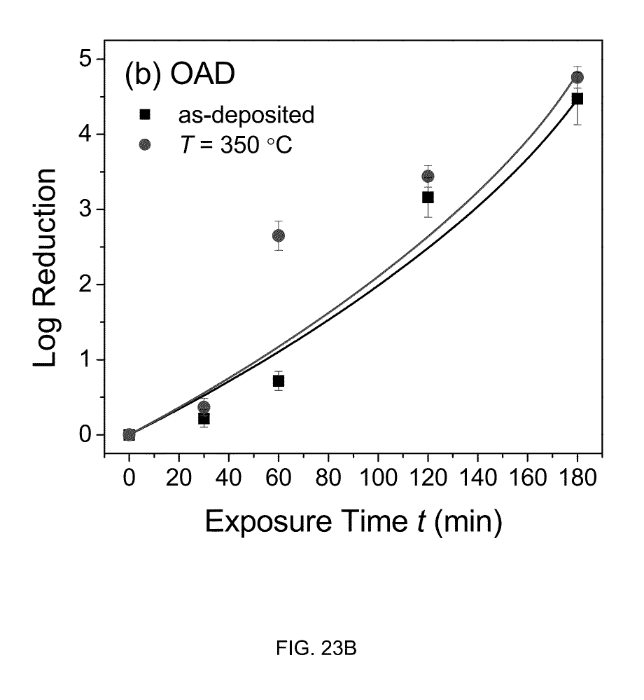

The visible light induced antimicrobial activities of the Fe₂O₃ thin films and nanorods against E. coli O157:H7 were measured and compared. For the biocidal experiment, only the as-deposited and T=about 350° C. samples were compared, as these represent the samples with the lowest and highest measured photocatalytic efficiencies, respectively. The results of the experiment are summarized in FIGS. 23A and 23B. It is observed that the bactericidal efficacies of the nanorod samples are much higher than the thin film samples. The as-deposited and T=about 350° C. thin films show about 1.1 and 1.5 log reductions in bacteria over about 3 hours, respectively, while the as-deposited and T=about 350° C. nanorod samples are exponentially more efficient, showing log reductions of about 4.6 and 4.9 over about 3 hours, respectively. It is difficult to compare these antimicrobial efficacy results with results from the literature due to large variations in reported experimental parameters such as initial bacteria concentration and strains, illumination intensity and wavelength range, substrate size, etc. Additionally, most antimicrobial tests of TiO₂ are conducted using UV light, while the Fe₂O₃ samples in this experiment were tested using visible light. However, it is worth noting that the log reductions of the nanorod samples compare favorably with the results published in the literature for the inactivation of E. coli using state of the art TiO₂-based coatings, which have reported log reductions that range from ˜3 to ˜5 over three hours in recent experiments,⁵⁴⁻⁵⁷ and also compare favorably with other photocatalytic materials such as sphalerite⁵⁸ and bismuth vanadate nanotubes,⁵⁹ both of which were recently reported to have log reductions of E. coli of ˜2.5 over three hours. Thus, these results indicate that Fe₂O₃ nanorods are candidates for antimicrobial applications, especially given the intrinsic benefits of α-Fe₂O₃ such as low cost, abundance, non-toxicity, visible light utilization, and FDA approval for food and medical applications.

The time dependent biocidal effect of a coated photocatalyst surface has not been well understood, though there are numerous models for suspended nanoparticle/biocidal solutions.⁶⁰⁻⁶³ It is necessary to develop a physical model of the antimicrobial experiment in order to quantify the bacterial inactivation rate of the samples. This system can be described by diffusive transport combined with a reactive boundary condition. The one-dimensional chemotaxis diffusion equation is given by,⁶⁴

$$\frac{\partial b}{\partial t} = - \frac{\partial }{\partial x} ( - D \frac{\partial b}{\partial x} + χ b \frac{\partial c}{\partial x} ) , \qquad ( 7 )$$

where b(x, t) is the bacteria concentration, D is the bacteria diffusion coefficient, χ is the chemotactic sensitivity coefficient, and c(x, t) is the chemoattractant concentration. If it is assumed that both D and χ are constant throughout the experiment and the chemoattractant gradient has no curvature, i.e., ∂²c/∂x²=0, Eq. (7) reduces to the one-dimensional advection equation for b(x, t),

$$\frac{\partial b}{\partial t} = D \frac{{\partial }^{2} b}{\partial {x}^{2}} - χ * \frac{\partial b}{\partial x} , \qquad ( 8 )$$

where χ* is the chemotactic sensitivity coefficient that has been modified by the chemoattractant gradient. The two boundary conditions are,

$$\begin{matrix}\frac{\partial b}{\partial x} {\vert}_{x = 0} = 0 , & ( 9 ) \\ \frac{\partial b}{\partial x} {\vert}_{x = L} = - \frac{{κ}_{b}}{D} b ( x = L , t ) , & ( 10 )\end{matrix}$$

where L is distance from the solution/ambient interface (x=0) to the solution/Fe₂O₃ interface (x=L), and κ_{b} is the bacterial inactivation rate of the sample. Equation 10 defines the biocidal effect of the surface. Thus, the major assumptions of this model are: the motional behavior of E. coli O157:H7 in an aqueous environment that is supported by a Fe₂O₃ film can be described by a one-dimensional chemotaxis equation; the volume of the aqueous environment does not change appreciably with time; bacteria cannot escape from ambient/solution interface; and bacteria are inactivated by the Fe₂O₃ film at a rate that is proportional to the bacteria concentration at the solution/Fe₂O₃ interface. Using the two boundary conditions, Eq. (9) and Eq. (10), and the initial condition that b(x, t=0)=b₀, the solution to Eq. (8) is given by (see Electronic Supplementary Information, ESI, for full derivation):

$$\begin{matrix}b ( ξ , t ) = {\sum }_{n = 1}^{∞} {c}_{n} {e}^{- D {λ}_{n}^{2} t} cos ( {λ}_{n} ξ ) , & ( 11 ) \\ ξ = x - χ * t , & ( 12 ) \\ {λ}_{n} = \frac{{κ}_{b}}{D} cot {λ}_{n} L , & ( 13 ) \\ {c}_{n} = \frac{2 {b}_{0} {λ}_{n} sin {λ}_{n} L}{{λ}_{n}^{2} L + {λ}_{n} sin {λ}_{n} L cos {λ}_{n} L} . & ( 14 )\end{matrix}$$

The experiment was modeled using the following values for the parameters: n=50; b₀=10⁷ CFU/ml; L=0.1 cm; D=2.6×10⁻⁵ cm²/s (average of Table II from Lewus and Ford);⁶⁵ χ*=4×10⁻⁵ cm²/s (10% of average of Table III from Lewus and Ford).⁶⁵ The bacterial inactivation rate, κ_{b}, was varied until the predicted curve matched the experimental datum at t=180 min. The results for κ_{b} range from κ_{b}=1.2×10⁴ cm/s for the as-deposited thin film sample to κ_{b}=4.8×10⁴ cm/s for the nanorod sample annealed at T=about 350° C.; a summary of the resulting curves are plotted in FIGS. 23A and 23B. The model and parameters predict a non-linear curve for the log reduction, and the agreement between the model and experimental data is reasonably good given the assumed values of D and χ* and the approximations made during the derivation (see ESI). Experimentally determined values of D and χ* could improve the quality of the fitting.

The slight increase in bacterial inactivation rate for both sets of films after annealing is unsurprising. However, the superior performance of the nanorods relative to the thin films is surprising, especially given the results from the photocatalytic experiment, where the thin films are found to be slightly more efficient than the nanorod samples. While the degradation pathways for both MB and E. coli O157:H7 rely on the oxidation processes, the physical sizes of MB (˜1 nm) and E. coli O157:H7 (˜1 μm) are different. Thus, the MB molecule can reach all of the exposed surfaces of the plate-like structures of the thin films and the nanorods of the OAD films, but E. coli O157:H7 is much larger than the lateral spacing of the thin films and nanorods and is, therefore, confined to the top surfaces of each film. Furthermore, as described above, direct contact with the Fe₂O₃ surface is extremely important for oxidative processes given the slow aqueous kinetics and the relatively low oxidation potential of the Fe₂O₃ films. Thus, it is clear that the ways in which E. coli O157:H7 adheres and interacts with the top surfaces of the thin films and nanorods determine their relative efficacy for antimicrobial applications. Not to be bound by any particular theory, however, given the greater biocidal effects of the nanorod samples, it is expected that the nanorod array morphology promotes longer contact times of E. coli O157:H7 with the Fe₂O₃ surface, while the bacteria should show an aversion to the prismatic ends of the thin film surface. The greater contact time with the α-Fe₂O₃ surface increase the likelihood that E. coli O157:H7 can be inactivated via the direct photochemical oxidation of intracellular coenzyme A.^{10,15}

The effects of surface properties on cell adhesion are still not well understood and are currently a hot topic in the literature. While no single theory has been established, surface energy, roughness, and zeta potential have been determined to be important factors governing the adhesion strength of bacteria, but the relative importance of the surface properties varies between experiments.⁶⁶⁻⁷⁰ In order to compare the surface energies of the films, the contact angle of a deionized water droplet on the Fe₂O₃ thin films and nanorod samples were measured and were found to be about 56.5° and about 23.5°, respectively. Thus, either E. coli O157:H7 shows a preference for the more hydrophilic surface of the nanorod film or that surface wettability is not an important parameter in this case. More likely, the surface morphology plays a greater role. It is difficult for the bacteria to conform to the very sharp surface features of the thin film, and, as described by Emerson et al., this inability prevents strong adhesion to the surface.⁶⁹ On the other hand, E. coli O157:H7 can conform more easily to the smoother edges and larger scale roughness of the top surface of the nanorods, promoting greater adhesion and longer contact times, and allowing more bacteria to be inactivated. The surface roughness of electron beam evaporated Fe₂O₃ thin films is an important effect on bactericidal efficacy.

### CONCLUSIONS

We have demonstrated that both Fe₂O₃ thin films and Fe₂O₃ nanorod arrays fabricated by electron beam evaporation are purely hematite (α-Fe₂O₃) using structural and optical methods. The thin films were found to be oriented nanocolumnar α-Fe₂O_{3 with exposed {}110} and {001} planes and the OAD films were found to be arrays of oriented α-Fe₂O₃ nanorods. Furthermore, the Fe₂O₃ thin films and Fe₂O₃ nanorods were found to be photocatalytically and antimicrobially active under visible light illumination. However, the different morphologies of the films (prismatic nanocolumn versus nanorod) and the different nature of the reactants (organic dye, ˜1 nm, versus bacteria, ˜1 μm) highlighted how adsorbate/surface interactions are an important consideration for photocatalytic and antimicrobial applications of α-Fe₂O₃ films. Specifically, strong absorbance of molecular reactants and strong adhesion of bacteria are required to maximize photo-induced degradation. A chemotactic mathematical model of bacterial inactivation was developed to quantify the antimicrobial efficiency of surface coatings. These results are important considerations for future designs of α-Fe₂O₃ antimicrobial coatings for the inactivation of E. coli O157:H7. Further experiments are underway in order to investigate how the morphology of electron beam evaporated α-Fe₂O₃ can be tuned to optimize bacterial contact with the photocatalytic surface in order to maximize its biocidal effects.

TABLE 1
Average crystallite sizes calculated from the {110} and {012} diffraction
peaks in the Fe₂O₃ thin films and nanorods.

| | |
|---|---|
| Thin Films | Nanorods |

| | {110} | {012} | {110} | {012} |
|---|---|---|---|---|
| Sample | (nm) | (nm) | (nm) | (nm) |
| as-deposited | 42 | 83 | 30 | 17 |
| T = 250° C. | 47 | 69 | 35 | 42 |
| T = 350° C. | 53 | 69 | 18 | 30 |
| T = 450° C. | 42 | 83 | 47 | 52 |

TABLE 2
Derived optical parameters of the Fe₂O₃ thin films and nanorods.

| | Thin Films | | | Nanorods |
|---|---|---|---|---|
| | Refractive | | Band | Band |
| | Index at | Porosity | Gap | Gap |
| Sample | 750 nm | (%) | (eV) | (eV) |
| as-deposited | 2.49 | 28.1 | 2.21 | 2.09 |
| T = 250° C. | 2.36 | 36.9 | 2.19 | 2.08 |
| T = 350° C. | 2.26 | 43.2 | 2.17 | 2.07 |
| T = 450° C. | 2.46 | 30.2 | 2.17 | 2.11 |

### REFERENCES

(1) Frenzen, P. D.; Drake, A.; Angulo, F. J.; Emerging Infections, P. J. Food Prot. 2005, 68, 2623.
(2) Andreoli, S. P.; Trachtman, H.; Acheson, D. W. K.; Siegler, R. L.; Obrig, T. G. Pediatr. Nephrol. 2002, 17, 293.
(3) Rodriguez, A.; McLandsborough, L. A. J. Food Prot. 2007, 70, 600.
(4) Tuttle, J.; Gomez, T.; Doyle, M. P.; Wells, J. G.; Zhao, T.; Tauxe, R. V.; Griffin, P. M. Epidemiol. Infect. 1999, 122, 185.
(5) Sawai, J. J. Microbiol. Methods 2003, 54, 177.
(6) Fu, G. F.; Vary, P. S.; Lin, C. T. J. Phys. Chem. B 2005, 109, 8889.
(7) Maness, P. C.; Smolinski, S.; Blake, D. M.; Huang, Z.; Wolfrum, E. J.; Jacoby, W. A. Appl. Environ. Microbiol. 1999, 65, 4094.
(8) Li, Q. L.; Mahendra, S.; Lyon, D. Y.; Brunet, L.; Liga, M. V.; Li, D.; Alvarez, P. J. J. Water Res. 2008, 42, 4591.
(9) Liou, J. W.; Chang, H. H. Arch. Immunol. Ther. Ex. 2012, 1.
(10) Matsunaga, T.; Tomoda, R.; Nakajima, T.; Wake, H. FEMS Microbiol. Lett. 1985, 29, 211.
(11) Hoffmann, M. R.; Martin, S. T.; Choi, W. Y.; Bahnemann, D. W. Chem. Rev. 1995, 95, 69.
(12) Sakthivel, S.; Janczarek, M.; Kisch, H. J. Phys. Chem. B 2004, 108, 19384.
(13) Foster, H. A.; Ditta, I. B.; Varghese, S.; Steele, A. Appl. Microbiol. Biotechnol. 2011, 90, 1847.
(14) Sunada, K.; Watanabe, T.; Hashimoto, K. J. Photochem. Photobiol. A 2003, 156, 227.
(15) Matsunaga, T.; Tomoda, R.; Nakajima, T.; Nakamura, N.; Komine, T. Appl. Environ. Microbiol. 1988, 54, 1330.
(16) Klahr, B. M.; Martinson, A. B. F.; Hamann, T. W. Langmuir 2011, 27, 461.
(17) Cesar, I.; Kay, A.; Gonzalez Martinez, J. A.; Grätzel, M. J. Am. Chem. Soc. 2006, 128, 4582.
(18) Chemyshova, I. V.; Hochella, M. F.; Madden, A. S. Phys. Chem. Chem. Phys. 2007, 9, 1736.
(19) Smith, W.; Ingram, W.; Zhao, Y. P. Chem. Phys. Lett. 2009, 479, 270.
(20) Smith, W.; Zhao, Y. P. J. Phys. Chem. C 2008, 112, 19635.
(21) Ye, D. X.; Zhao, Y. P.; Yang, G. R.; Zhao, Y. G.; Wang, G. C.; Lu, T. M. Nanotechnology 2002, 13, 615.
(22) Smith, W.; Zhang, Z. Y.; Zhao, Y. P. J. Vac. Sci. Technol. B 2007, 25, 1875.
(23) He, Y. P.; Zhang, Z. Y.; Zhao, Y. P. J. Vac. Sci. Technol. B 2008, 26, 1350.
(24) Barkocy-Gallagher, G. A.; Arthur, T. M.; Siragusa, G. R.; Keen, J. E.; Elder, R. 0.; Laegreid, W. W.; Koohmaraie, M. Appl. Environ. Microbiol. 2001, 67, 3810.
(25) Harmon, B. G.; Brown, C. A.; Tkalcic, S.; Mueller, P. O. E.; Parks, A.; Jain, A. V.; Zhao, T.; Doyle, M. P. J. Food Prot. 1999, 62, 574.
(26) Tkalcic, S.; Zhao, T.; Harmon, B. G.; Doyle, M. P.; Brown, C. A.; Zhao, P. J. Food Prot. 2003, 66, 1184.
(27) Hodgkinson, I.; Wu, Q. H.; Hazel, J. Appl. Opt. 1998, 37, 2653.
(28) Tait, R. N.; Smy, T.; Brett, M. J. Thin Solid Films 1993, 226, 196.
(29) Tanto, B.; Ten Eyck, G.; Lu, T. M. J. Appl. Phys. 2010, 108, 026107.
(30) Zhu, H.; Cao, W.; Larsen, G. K.; Toole, R.; Zhao, Y. J. Vac. Sci. Technol. B 2012, 30, 030606.
(31) Groza, J. R. Nanostruct. Mater. 1999, 12, 987.
(32) Wen, X.; Wang, S.; Ding, Y.; Wang, Z. L.; Yang, S. J. Phys. Chem. B 2005, 109, 215.
(33) Demianets, L. N.; Pouchko, S. V.; Gaynutdinov, R. V. J. Cryst. Growth 2003, 259, 165.
(34) Bersani, D.; Lottici, P.; Montenero, A. J. Raman Spectrosc. 1999, 30, 355.
(35) McCarty, K. F. Solid State Commun. 1988, 68, 799.
(36) Martin, T.; Merlin, R.; Huffman, D.; Cardona, M. Solid State Commun. 1977, 22, 565.
(37) de Faria, D. L. A.; Venancio Silva, S.; de Oliveira, M. T. J. Raman Spectrosc. 1997, 28, 873.
(38) Glasscock, J.; Barnes, P.; Plumb, I.; Bendavid, A.; Martin, P. Thin Solid Films 2008, 516, 1716.
(39) Manifacier, J.; Gasiot, J.; Fillard, J. J. Phys. E 2001, 9, 1002.
(40) Yoldas, B. E.; Partlow, D. P. Thin Solid Films 1985, 129, 1.
(41) Lethy, K. J.; Beena, D.; Pillai, V. P. M.; Ganesan, V. J. Appl. Phys. 2008, 104.
(42) Akl, A. A. Appl. Surf. Sci. 2004, 233, 307.
(43) Garcia-Lobato, M. A.; Martinez, A. I.; Castro-Roman, M.; Falcony, C.; Escobar-Alarcon, L. Physica B 2011, 406, 1496.
(44) Souza, F. L.; Lopes, K. P.; Nascente, P. A. P.; Leite, E. R. Sol. Energy Matr. Sol. Cells 2009, 93, 362.
(45) Desai, J. D.; Pathan, H. M.; Min, S. K.; Jung, K. D.; Joo, O. S. Appl. Surf. Sci. 2006, 252, 2251.
(46) Kay, A.; Cesar, I.; Gratzel, M. J. Am. Chem. Soc. 2006, 128, 15714.
(47) Gao, Q.-X.; Wang, X.-F.; Di, J.-L.; Wu, X.-C.; Tao, Y.-R. Catal. Sci. Technol. 2011, 1, 574.
(48) Liu, X.; Liu, J.; Chang, Z.; Sun, X.; Li, Y. Catal. Commun. 2011, 12, 530.
(49) Zheng, Y.; Cheng, Y.; Wang, Y.; Bao, F.; Zhou, L.; Wei, X.; Zhang, Y.; Zheng, Q. J. Phys. Chem. B 2006, 110, 3093.
(50) Reddy, B. V.; Rasouli, F.; Hajaligol, M. R.; Khanna, S, N. Fuel 2004, 83, 1537.
(51) Weiss, W.; Ranke, W. Prog. Surf. Sci. 2002, 70, 1.
(52) Hardee, K. L.; Bard, A. J., J. Electrochem. Soc., 1977, 124, 215.
(53) Miyauchi, M.; Nakajima, A.; Watanabe, T.; Hashimoto, K. Chem. Mater. 2002, 14, 2812.
(54) Chawengkijwanich, C.; Hayata, Y. Int. J. Food Microbiol. 2008, 123, 288.
(55) Foster, H. A.; Sheel, D. W.; Sheel, P.; Evans, P.; Varghese, S.; Rutschke, N.; Yates, H. M. J. Photochem. Photobiol. A 2010, 216, 283.
(56) Qiu, X.; Miyauchi, M.; Sunada, K.; Minoshima, M.; Liu, M.; Lu, Y.; Li, D.; Shimodaira, Y.; Hosogi, Y.; Kuroda, Y.; Hashimoto, K. ACS Nano 2011, 6, 1609.
(57) Dunnill, C. W.; Ansari, Z.; Kafizas, A.; Perni, S.; Morgan, D. J.; Wilson, M.; Parkin, I. P. J. Mater. Chem. 2011, 21, 11854.
(58) Chen, Y.; Lu, A.; Li, Y.; Zhang, L.; Yip, H. Y.; Zhao, H.; An, T.; Wong, P. K. Environ. Sci. Technol. 2011, 45, 5689.
(59) Wang, W.; Yu, Y.; An, T.; Li, G.; Yip, H. Y.; Yu, J. C.; Wong, P. K. Environ. Sci. Technol. 2012, 46, 4599.
(60) Wei, C.; Lin, W. Y.; Zainal, Z.; Williams, N. E.; Zhu, K.; Kruzic, A. P.; Smith, R. L.; Rajeshwar, K. Environ. Sci. Technol. 1994, 28, 934.
(61) Horie, Y.; David, D. A.; Taya, M.; Tone, S. Ind. Eng. Chem. Res. 1996, 35, 3920.
(62) Koizumi, Y.; Taya, M. Biochem. Eng. J. 2002, 12, 107.
(63) Sun, D. D.; Tay, J. H.; Tan, K. M. Water Res. 2003, 37, 3452.
(64) Keller, E. F.; Segel, L. A. J. Theor. Biol. 1971, 30, 225.
(65) Lewus, P.; Ford, R. M. Biotechnol. Bioeng. 2001, 75, 292.
(66) Absolom, D. R.; Lamberti, F. V.; Policova, Z.; Zingg, W.; van Oss, C. J.; Neumann, A. Appl. Environ. Microbiol. 1983, 46, 90.
(67) Bos, R.; van der Mei, H. C.; Busscher, H. J. FEMS Microbiol. Rev. 1999, 23, 179.
(68) Gottenbos, B.; Grijpma, D. W.; van der Mei, H. C.; Feijen, J.; Busscher, H. J. J. Antimicrob. Chemother. 2001, 48, 7.
(69) Emerson; Bergstrom, T. S.; Liu, Y.; Soto, E. R.; Brown, C. A.; McGimpsey, W. G.; Carnesano, T. A. Langmuir 2006, 22, 11311.
(70) Li, B.; Logan, B. E. Colloids Surf. B 2004, 36, 81.

It should be noted that ratios, concentrations, amounts, and other numerical data may be expressed herein in a range format. It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a concentration range of “about 0.1% to about 5%” should be interpreted to include not only the explicitly recited concentration of about 0.1 wt % to about 5 wt %, but also include individual concentrations (e.g., 1%, 2%, 3%, and 4%) and the sub-ranges (e.g., 0.5%, 1.1%, 2.2%, 3.3%, and 4.4%) within the indicated range. The term “about” can include ±1%, ±2%, ±3%, ±4%, ±5%, ±6%, ±7%, ±8%, ±9%, or ±10%, or more of the numerical value(s) being modified. In an embodiment, the term “about” can include traditional rounding according to the numerical value. In addition, the phrase “about ‘x’ to ‘y’” includes “about ‘x’ to about ‘y’”.

It should be emphasized that the above-described embodiments of the present disclosure are merely possible examples of implementations, and are merely set forth for a clear understanding of the principles of the disclosure. Many variations and modifications may be made to the above-described embodiments. All such modifications and variations are intended to be included herein within the scope of this disclosure and protected by the following claims.

Therefore, at least the following is claimed:

1. An antimicrobial material comprising iron oxide, wherein the iron oxide is selected from the group consisting of: iron (III) oxide (Fe₂O₃), iron (II) oxide (FeO), iron (II, III) oxide (Fe₃O₄), and a combination thereof.

2. The antimicrobial material of claim 1, wherein the iron oxide comprises α-Fe₂O₃.

3. The antimicrobial material of claim 2, wherein the iron oxide comprises a thin film comprised of an array of prismatic nanocolumns.

4. The antimicrobial material of claim 3, wherein a thickness of the thin film is about 900 nm to 1 μm.

5. The antimicrobial material of claim 1, wherein the antimicrobial material is photocatalytically and antimicrobially active under visible light illumination.

6. The antimicrobial material of claim 2, wherein the iron oxide comprises an array of aligned tilted nanorods.

7. The antimicrobial material of claim 6, wherein the nanorods are inclined at an angle β with respect to a substrate normal of about 40° to 50°, wherein a length of the individual nanorods is about 1450 to 1550 nm, and wherein a density of the nanorods is about 5 to 15 rods/μm².

8. The antimicrobial material of claim 6, wherein the nanorod array comprises a film, wherein a thickness of the nanorod array film is about 1 to 2 μm.

9. The antimicrobial material of claim 6, wherein the antimicrobial material is photocatalytically and antimicrobially active under visible light illumination.

10. The antimicrobial material of claim 9, wherein the antimicrobial material kills bacteria on contact when exposed to visible light.

11. The antimicrobial material of claim 10, wherein the bacteria comprise E. coli O157:H7.

12. The antimicrobial material of claim 2, wherein the iron oxide comprises nanoparticles, wherein the nanoparticles comprise a shape selected from the group consisting of: spherical, cubical, rod, and a combination thereof.

13. A method of making an antimicrobial iron oxide material comprising:
depositing iron oxide by a physical method on a substrate to form a sample, wherein the physical method is selected from the group consisting of: electron beam physical vapor deposition, oblique angle deposition (OAD), glancing angle deposition (GLAD), chemical precipitation, and a combination thereof, and wherein the iron oxide is selected from the group consisting of: iron (III) oxide (Fe₂O₃), iron (II) oxide (FeO), iron (II, III) oxide (Fe₃O₄), and a combination thereof; and
annealing the sample, wherein the sample is annealed at about 250 to 450° C.

14. The method of claim 13, wherein the iron oxide comprises α-Fe₂O₃.

15. The method of claim 13, wherein the OAD method comprises an angle of deposition that is at least about 70°, and wherein tilted nanorod arrays comprised of iron oxide are formed.

16. The method of claim 13, wherein the electron beam physical vapor deposition comprises depositing a thin film of iron oxide with a vapour incident angle of 0°, and wherein a thin film comprised of an array of prismatic nanocolumns is formed.

17. The method of claim 13, wherein the parameters of the physical method are adjusted to deposit iron oxide in a form to optimize bacteria contact with the photocatalytic surface of the iron oxide to maximize biocidal effects.

18. An antimicrobial material comprising α-Fe₂O₃.

19. The antimicrobial material of claim 18, wherein the material comprises a coating, wherein the coating is applied to an article selected from the group consisting of: a tile, a curtain, a tool, a food package, a food item, and a combination thereof.

20. The antimicrobial material of claim 19, wherein the coating is used for intact and non-intact beef products/ground beef food packaging applications.

21. A method of killing bacteria comprising exposing at least one bacterium to an antimicrobial material comprising α-Fe₂O₃ under visible light.
